(19) United States
(12) Patent Application Publication
(10) Pub. No.: US 2015/0212717 A1
(43) Pub. Date: Jul. 30, 2015

(54) DASHBOARD AND CONTROL POINT CONFIGURATORS

(71) Applicant: Honeywell International Inc., Morristown, NJ (US)

(72) Inventors: Ajay Nair, Bangalore (IN); Liwen Yu, Acton, MA (US); Wei Hua, Acton, MA (US); Prabhat Ranjan, Bangalore (IN); Upender Paravastu, Bangalore (IN); Robert Klamka, Westford, MA (US); Christopher Martin, Sterling, MA (US); Sreedharan Venkataraman, Bangalore (IN); Jijji Ramanathan, Bangalore (IN); James Barrette, Ashburnham, MA (US)

(73) Assignee: Honeywell International Inc., Morristown, NJ (US)

(21) Appl. No.: 14/169,083

(22) Filed: Jan. 30, 2014

(51) Int. Cl. G06F 3/0484; G06F 3/0482; G06F 3/0486

(52) U.S. Cl. CPC G06F 3/04847; G06F 3/0486; G06F 3/0482

(57) ABSTRACT

An approach for dashboard and point configuration. A dashboard may be provided for a particular environment and have user defined gadgets. The dashboard and gadgets may be mapped to a web dashboard. The dashboard may be modified and configured. The gadgets may be moved, reconfigured and resized on the dashboard. A user may have a single view where the control points may be viewed and identify to which an entity that they are mapped. There may be a customized view of where the points can be identified that have been associated to which dashboard.

### BACKGROUND

The present disclosure pertains to dashboards and gadgets, particularly to dashboard and point configurators.

### SUMMARY

The disclosure reveals an approach for dashboard and point configuration. A dashboard may be provided for a particular environment and have user defined gadgets. The dashboard and gadgets may be mapped to a web dashboard. The dashboard may be modified and configured. The gadgets may be moved, reconfigured and resized on the dashboard. A user may have a single view where the control points may be viewed and identify to which an entity that they are mapped. There may be a customized view of where the points can be identified that have been associated to which dashboard.

### BRIEF DESCRIPTION OF THE DRAWING

FIG. 1 is a diagram of dashboard;

FIG. 2 is a diagram of details that support the dashboard;

FIG. 3 is a diagram of screen shot of an example workbench dashboard configurator;

FIG. 4 is a diagram showing where a workbench dashboard configurator may be launched;

FIG. 5 is a diagram of an example workbench dashboard configurator framework;

FIG. 6 is a diagram showing a screen of a workbench dashboard configurator having a dashboard list by name;

FIG. 7 is a diagram of a screen showing a dashboard list, a dashboard selected and gadgets in place;

FIG. 8 is a diagram of a screen that shows areas for designating dashboard information, gadget layout, and gadget properties;

FIG. 9 is a diagram of a dashboard information screen;

FIG. 10 is a diagram of a screen showing a gadget layout with a popup menu 19

FIG. 11 is a diagram of a screen showing a resize gadget dialog;

FIG. 12 is a diagram where a selected gadget is resized;

FIG. 13 is a diagram where another selected gadget is resized;

FIG. 14 shows a screen of a dialog when a gadget resize may not be necessarily allowed;

FIG. 15 is a screen showing dashboard configurator command buttons;

FIG. 16 is a diagram of a screen showing a save dashboard reminder dialog;

FIG. 17 is a diagram of a screen showing a designated gadget with a border around it and a corresponding screen for a trend gadget configuration;

FIG. 18 is a diagram of a screen where a point selector may be used to select points for live trend plotting;

FIG. 19 is a diagram of a screen portion where a time range may be selected for data to be trended;

FIG. 20 is a diagram of a screen showing a point selector;

FIG. 21 is a diagram of screen where one may select an entity;

FIG. 22 is a diagram of a selected point list that may have a fix option;

FIG. 23 is a diagram showing that after a fix, a new item to be fixed may be searched;

FIG. 24 is a diagram showing a result after valid configurations are done from the point selector;

FIG. 25 is a diagram of a point viewer gadget that permits a user to view a list of live Boolean or numeric points across a job;

FIG. 26 is a diagram of a gauge gadget configuration;

FIG. 27 is a diagram of an entity information gadget configuration;

FIG. 28 is a diagram showing a point value gadget configuration;

FIG. 29 is a diagram of a web connector gadget configuration;

FIG. 30 is a diagram of a chooser for selecting a dashboard for a URL;

FIG. 31 is a diagram that shows a default icon image that may appear in absence of an icon selection;

FIG. 32 is a diagram showing that a new URL may be launched in the same tab, a new tab or a new window;

FIG. 33 is a diagram of a screen for selection of a point value gadget and a screen for point value properties;

FIG. 34 is a diagram where a launch selector button may be pressed to get a point entity selector;

FIG. 35 is a diagram of a point entity selector;

FIG. 36 is a diagram of where a multi-selection may be permitted for entities;

FIG. 37 is a diagram of where one may double-click a VFPT row to enter a new display name;

FIG. 38 is a diagram of how one may delete a VFPT;

FIG. 39 is a diagram of an alarm gadget selection and an alarm point status gadget configuration;

FIG. 40 is a diagram of point chart gadget selection and a point chart gadget configuration;

FIG. 41 is a diagram showing a point selector where one may select an entity and a number of numeric points;

FIG. 42 is a diagram of a notes gadget selection and a notes gadget configuration;

FIG. 43 is a diagram showing a canvas gadget configuration;

FIG. 44 is a diagram of an image slot's folder icon that may be clicked to choose a background picture or image overlaid with point values of a canvas gadget;

FIG. 45 is a diagram that shows an example background picture or image;

FIG. 46 is a diagram of a launched point selector tool;

FIG. 47 is a diagram of where points may be removed or edited from the point selector tool by clicking on a point list;

FIG. 48 is a diagram where points may be listed under a point coordinate list and be opened to expose their details;

FIG. 49 is a diagram of a PC dashboard chooser;

FIG. 50 is a diagram of gadgets and a control loop gadget configuration for a selected control loop gadget;

FIG. 51 is a diagram of a control loop configuration screen;

FIG. 52 is a diagram of a control status control loop chooser;

FIG. 53 is a diagram of a folder for a component Ord which may be selected;

FIG. 54 is a diagram of an entity status gadget configuration screen;

FIG. 55 is a diagram of the entity status gadget configuration with a an entity chooser;

FIGS. 56 and 57 are diagrams showing a list of points with names and various properties;

FIG. 58 is a diagram showing that one may edit VFPT's, and manage history, archiving and history export;

FIG. 59 is a diagram of a screen for managing history settings; and

FIG. 60 is a diagram of a screen for managing database archiving.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

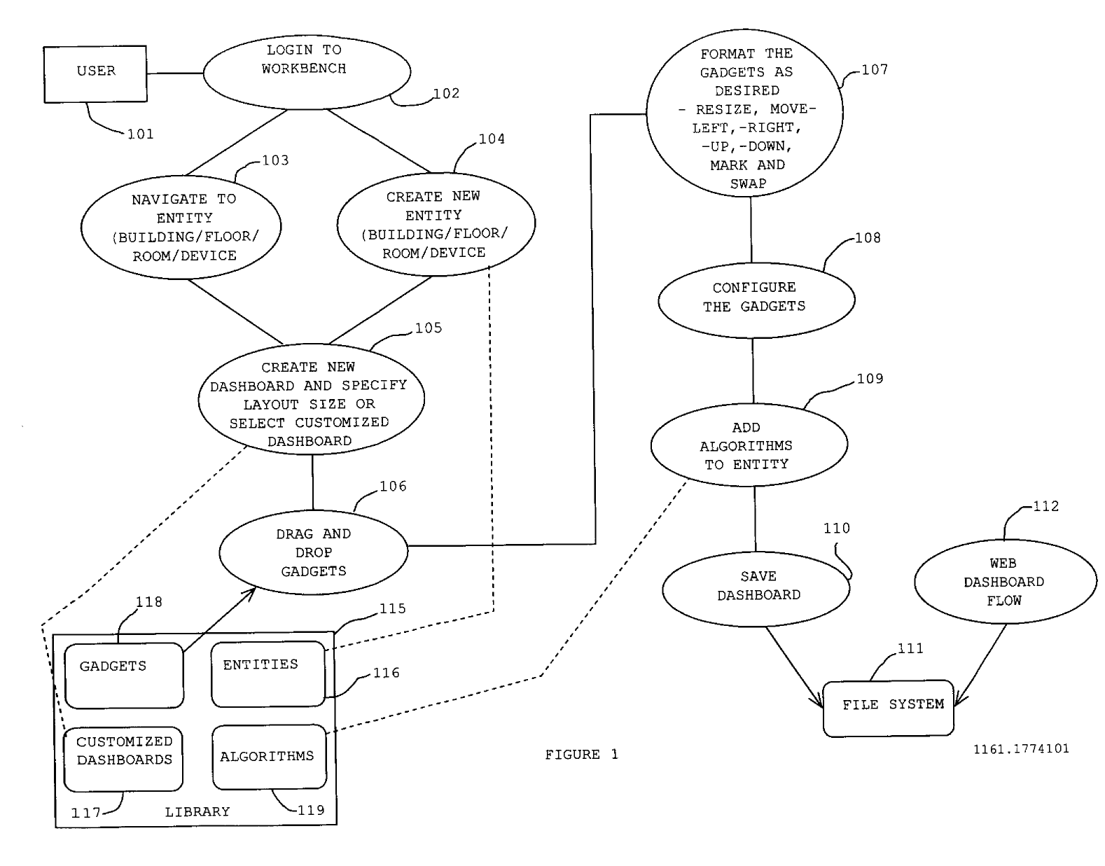

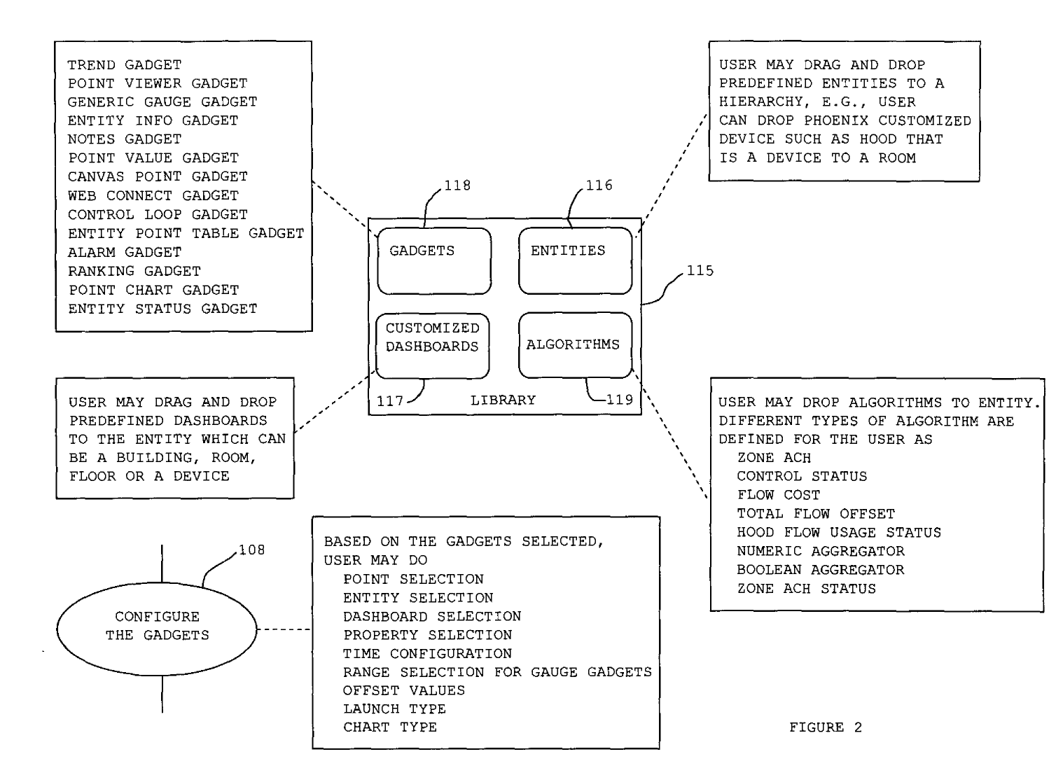

FIG. 1 is a diagram of dashboard that is made. FIG. 2 is a diagram of further details supporting the diagram of FIG. 1. A one as a user 101 may login to a Phoenix™ workbench at symbol 102. One may navigate to an entity (e.g., a building, floor, room or device) at symbol 103 or create a new entity at symbol 104. Entities may be available at symbol 116 of a Phoenix library 115. One may create a new dashboard and specify a layout size or select a customized dashboard at symbol 105. Customized dashboards may be available at symbol 117 at library 115. One may drag and drop gadgets on to the dashboard at symbol 106. Gadgets may be available at symbol 118 at library 115. One may format the gadgets as needed or desired, such as resize, move left, right, up, down, and mark and swap, at symbol 107. The gadgets may be configured at symbol 108. Algorithms may be added to the entity at symbol 109. Algorithms may be available at symbol 119 at library 115. The dashboard may be saved at symbol 110 to a file system 111. There may be a web dashboard flow from symbol 112 to file system 111.

From entities 116 at library 115, a user may drag and drop predefined entities to the hierarchy, e.g., a user may drop a customized device such as hood that can be a device to a room.

From customized dashboards 117 at library 115, a user may drag and drop predefined dashboards to the entity which can be a building, floor or a device.

Gadgets 118 at library 115 may incorporate a trend gadget, a point viewer gadget, a generic gauge gadget, an entity info gadget, a notes gadget, a point value gadget, a canvas point gadget, a web connect gadget, a control loop gadget, an entity point table gadget, an alarm gadget, a ranking gadget, a point chart gadget, and an entity status gadget. Other types of gadgets may be incorporated as gadgets 118 at library 115.

When configuring gadgets at symbol 108, based on the gadgets selected, user may do point selection, entity selection, dashboard selection, property selection, time configuration, and range selection for gauge gadgets, offset values, launch types and chart types. Other selections and configurations of gadgets may be incorporated.

From algorithms 119 at library 115, a user may drop algorithms to entity. Different types of algorithm may defined for the user as a zone ACH, control status, flow cost, total flow offset, hood flow usage status, a numeric aggregator, a Boolean aggregator, and zone ACH status. There may be other types of algorithms.

There may be an easy and intuitive workbench dashboard configurator for such things as critical room environment solutions. The home dashboard may be a workbench configurator in Niagara™ for building solutions. It has easy customization and configuration for points. It is simple and has an easy way of maintaining the dashboard and widgets. It has an easy way of duplicating the dashboards with all the widgets and then auto mapping the points, algorithms, and so forth. It can add a template dashboard library or entity and points will be auto mapped with entity. It can do resizing of widgets at run time.

There needs to exist a solution for Phoenix control technician to configure the dashboard with predefined and specific gadgets in the workbench. The solution may have the following features.

A dashboard may be created for any environment. The dashboard may address configurator needs of a critical room environment. There may be a provision to create user defined gadgets and meet its specific configuration. There may be an option of mapping the dashboard and gadgets created from workbench to a web dashboard. There may be an option of mapping customized algorithms and its output to a user specified gadget. There may be options of different modes and styles of gadgets. There may be an option of an easy and intuitive way of specifying layouts. There may be an option of reconfiguring and resizing the gadgets in an intuitive way. There may be an option of shifting the gadgets in any direction in an intuitive way. There may a provision of auto populating the gadgets with user defined configurations.

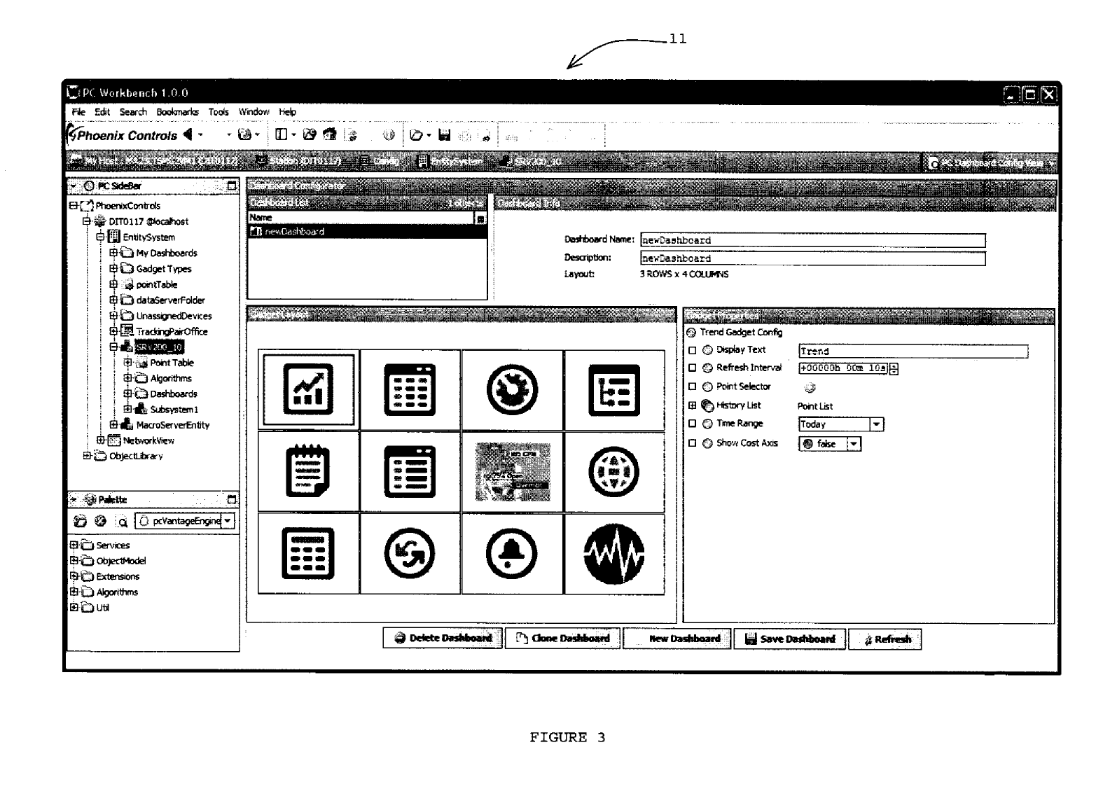

FIG. 3 is a diagram of screen shot of an example workbench dashboard configurator 11. The workbench dashboard configurator may provide a user-friendly interface to assist in the following. That may be to edit an existing dashboard by modifying dashboard properties and adding, removing and/or configuring gadgets in the dashboard. The interface may assist in creating new a dashboard, deleting a dashboard, resizing gadgets, dragging and dropping gadgets, and shifting gadgets. The interface may be very intuitive, auto refresh and manual refresh support enabled, and cost axis supported. The interface may have an option to specify the types of charts to be displayed based on user needs. A large number of predefined user specific gadgets may be created to let the user configure the points based on their needs.

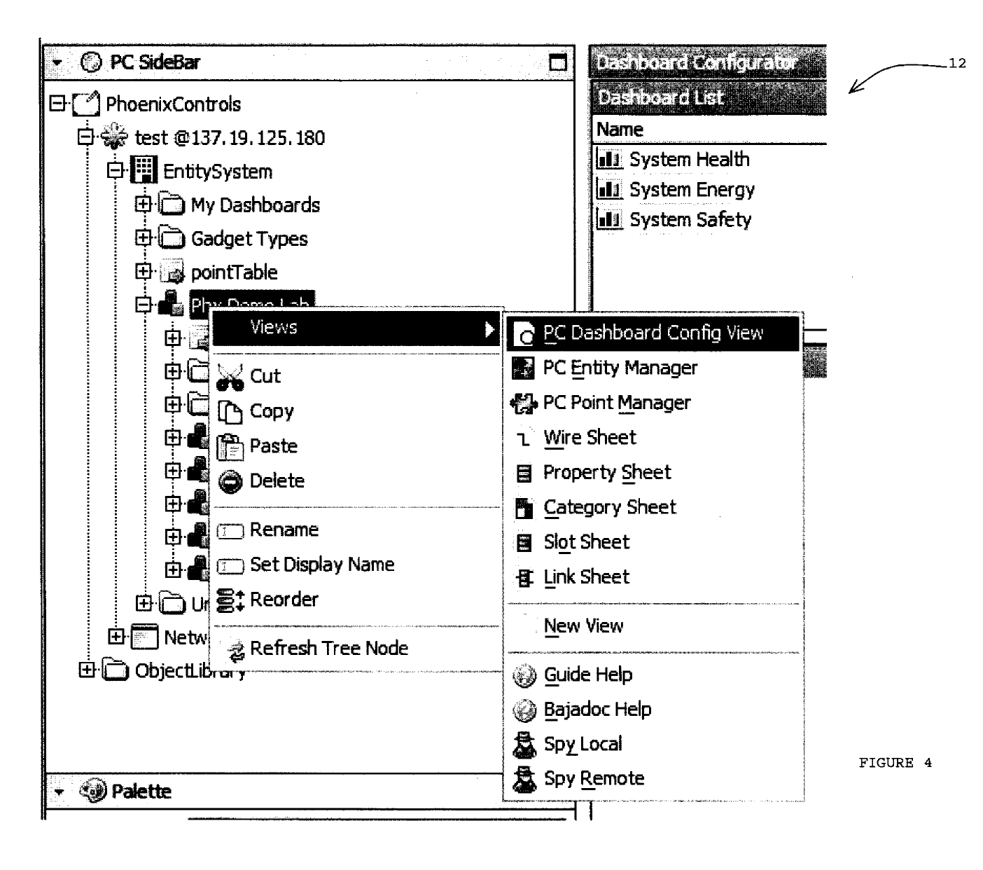

The workbench dashboard configurator may be launched by double-clicking on any Vantage™ entity node inside a Vantage side bar, or selecting entity node popup menu item “Views Vantage Dashboard Config View” as shown in a diagram of screen 12 in FIG. 4.

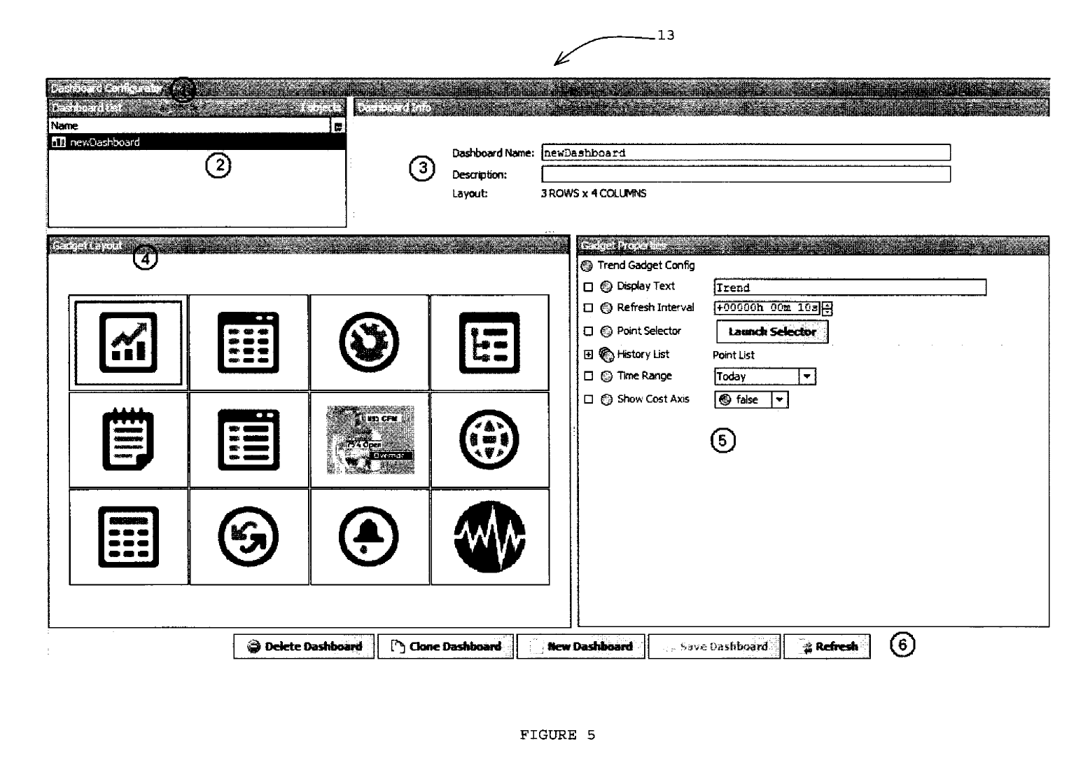

Workbench dashboard configurator GUI framework may be noted. FIG. 5 is a diagram of an example workbench dashboard configurator framework. A table for a workbench dashboard configurator GUI may have elements which may incorporate: 1) Item# Name Description; 2) Screen Title Bar Dashboard Configurator Title Bar; 3) Dashboard List Display list of dashboards available in the launching entity that may have single select and allow a drag and drop of dashboard templates from object model library; 4) Dashboard Info Dashboard properties of selected dashboard in “Dashboard List”; 5) Gadget Layout Gadget placement in selected dashboard; 6) Gadget Properties Gadget configurator for selected gadget in “Gadget Layout” which may be highlighted with a blue rectangle on a screen of the configurator; and 7) Command Group Dashboard configurator command buttons.

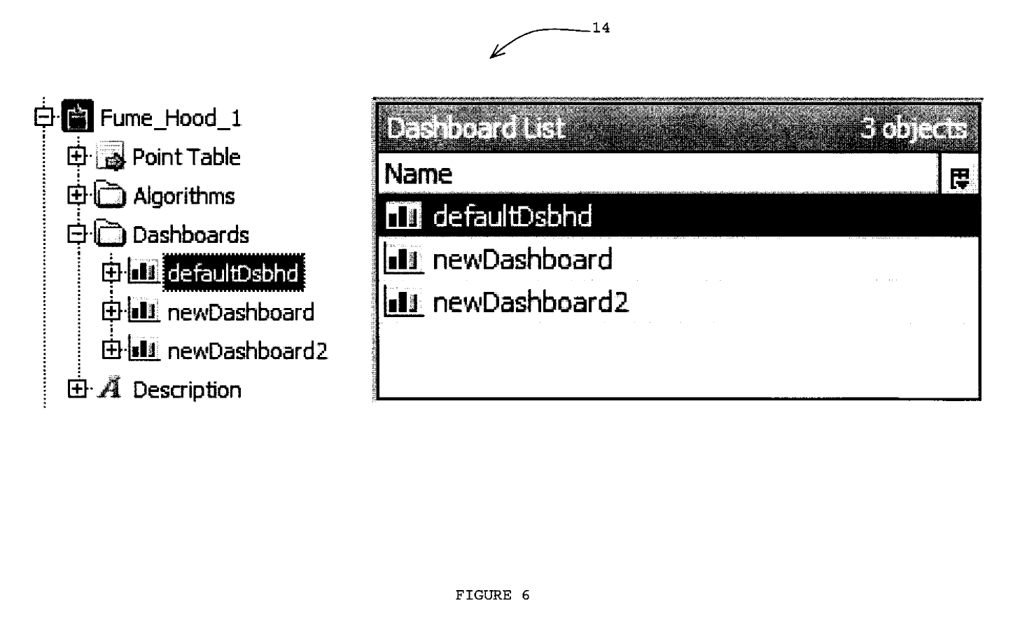

A dashboard list may display dashboards available in launching entity. The “Name” used in list may match a dashboard display name in side bar. FIG. 6 is a diagram showing a screen 14 of a workbench dashboard configurator having a “Dashboard List” by “Name”.

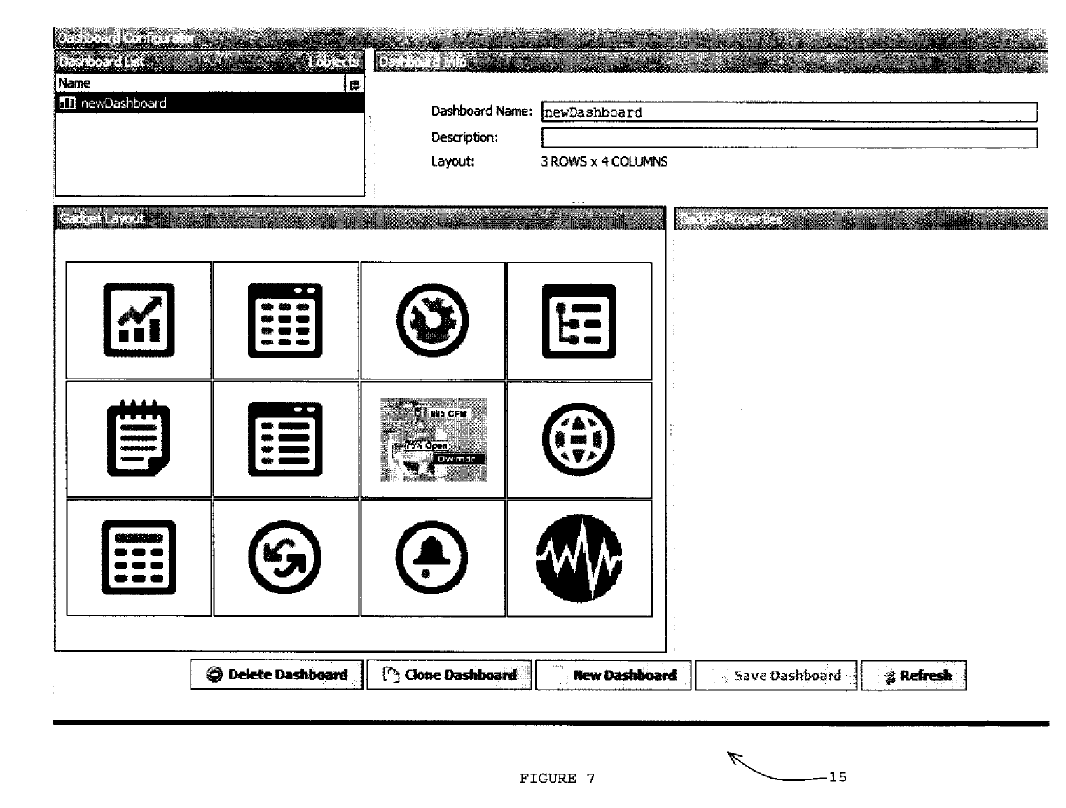

When a dashboard is selected, the following items may occur. A dashboard info screen may be updated with selected dashboard properties. A gadget layout screen may be updated with current gadget layout of selected dashboard. A gadget properties screen may be empty until a gadget is selected in “Gadget Layout”. FIG. 7 is a diagram of a screen 15 showing a dashboard list and a dashboard selected.

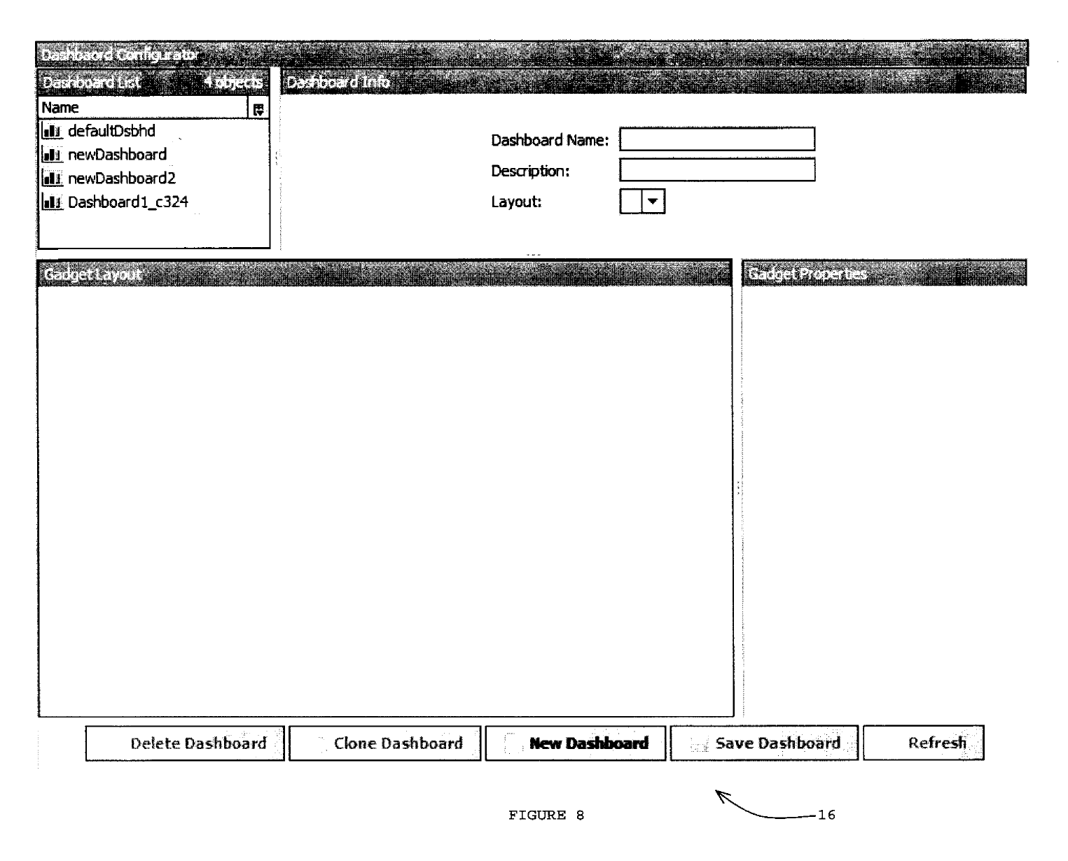

FIG. 8 is a diagram of a screen 16 that shows “Dashboard Info”, “Gadget Layout”, and “Gadget Properties”. The various portions of screen 16 are empty when no dashboard is selected in the list.

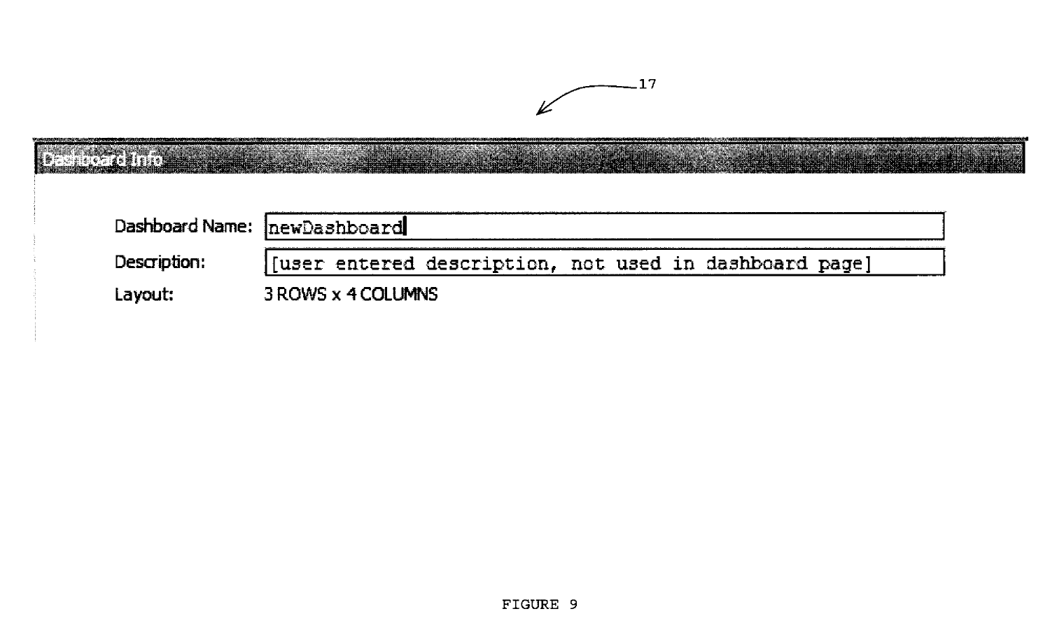

FIG. 9 is a diagram of a screen 17 revealing dashboard info incorporating a dashboard name description and layout.

GUI elements may incorporate name value notes, a dashboard name text with a maximum length of 20 characters, displayed in dashboard page as a dashboard name, description text saved in a dashboard xml file but not necessarily used in a web dashboard, layout text (read only) in that the current layout setting in dashboard cannot change. The layout may be determined when dashboard is created.

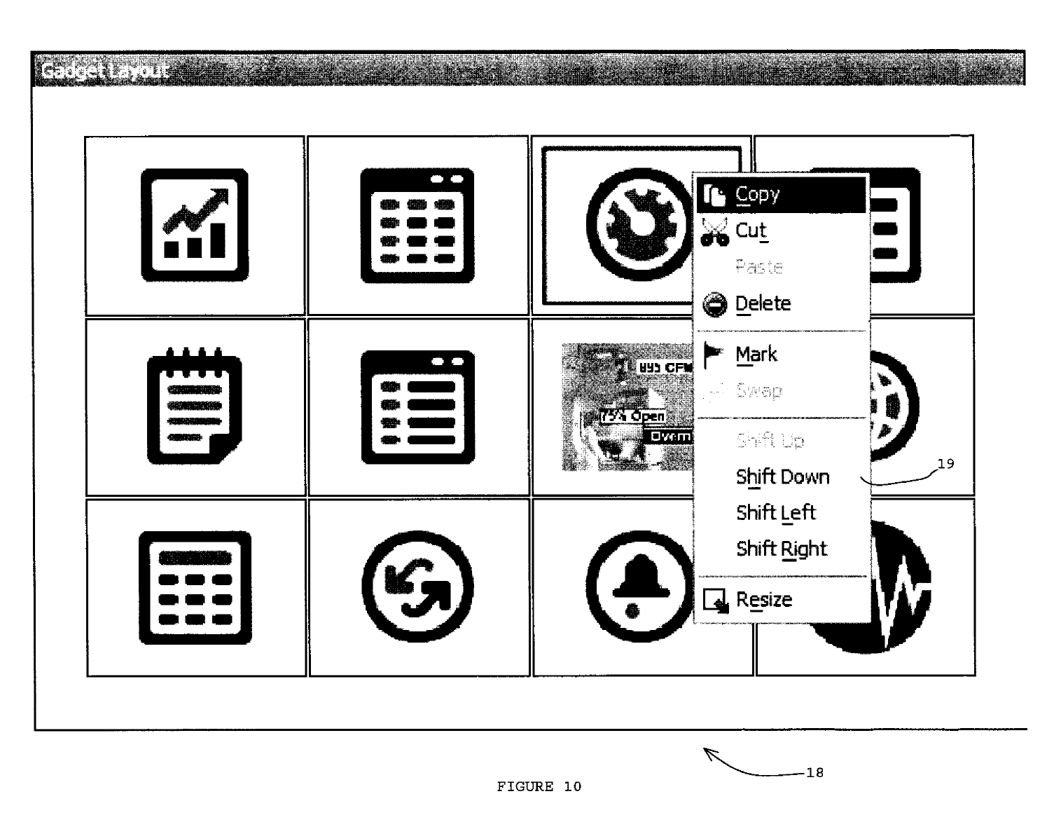

FIG. 10 is a diagram of a screen 18 showing a gadget layout with a popup menu 19. There may be popup menu rules and menu item function rules. Copy may mean copy the selected gadget. Enabled may mean if one and only one gadget is selected. Cut may mean prepare for cut and paste, with a selected gadget as a source. Paste may mean paste a previously copied or cut gadget into the selected location.

Enabled may mean when the following conditions are met: 1) A gadget was copied or cut before; and 2) The size of source gadget and the target location must be the same. A current non-empty gadget that occupies the target location may be overridden after a user confirmation. With delete, one may delete selected gadget(s) or can delete multiple gadgets at the same time. Select multiple gadgets may be achieved by holding the control button down while clicking on gadgets. Selected gadgets may be framed by blue rectangle around the respective gadgets on a screen.

Mark may mean prepare for mark-and-swap. One may use a selected gadget as a source gadget. Swap may mean swap a location of a selected gadget with a previously marked gadget. It may be enabled if sizes of the source gadget and selected gadget match.

Shift may incorporate an up/down/left/right shift of a selected gadget. It may be enabled if the current layout allows shift.

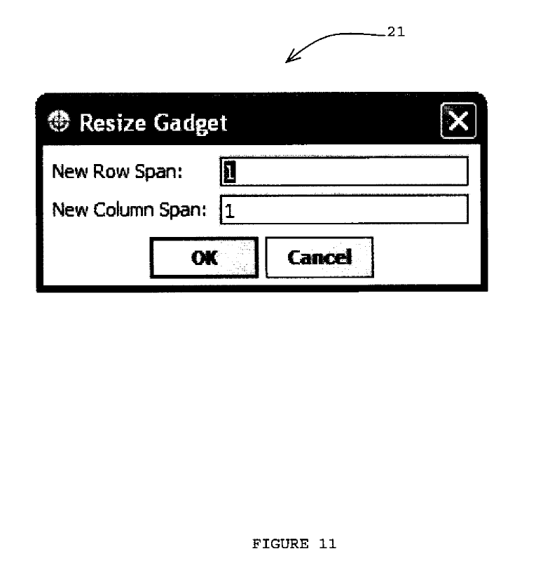

Resize may mean a change row span and/or column span of a selected gadget. It is enabled if one and only one gadget is selected. FIG. 11 is a diagram of a screen 21 showing a resize gadget dialog. The resize gadget dialog may appear after a user selects “Resize” in a popup menu. One may press OK to resize gadget or press cancel to keep current size intact.

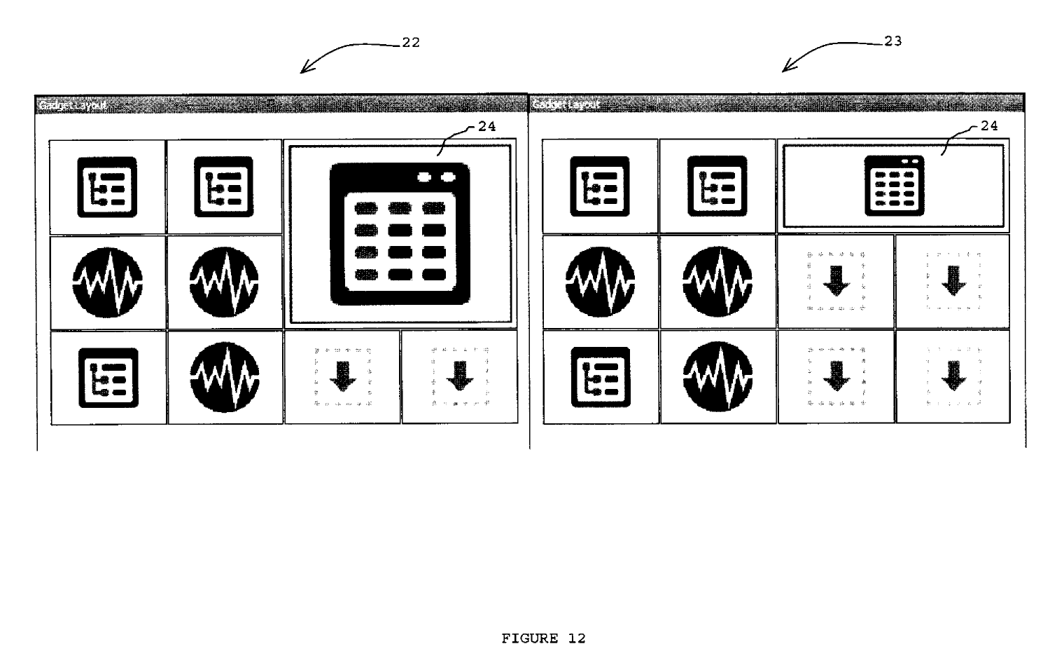

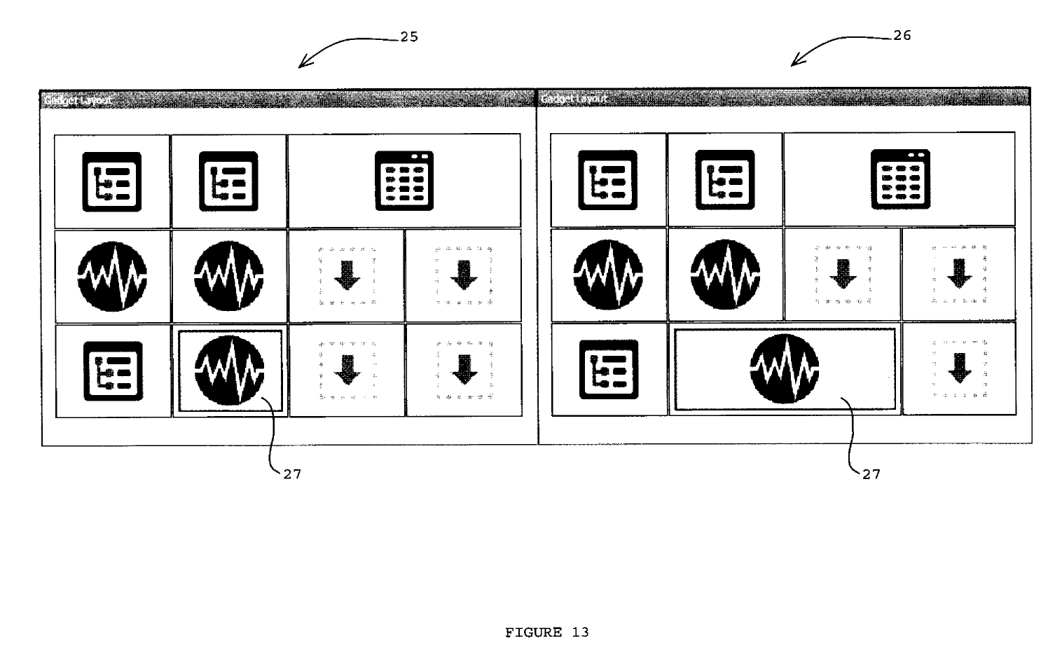

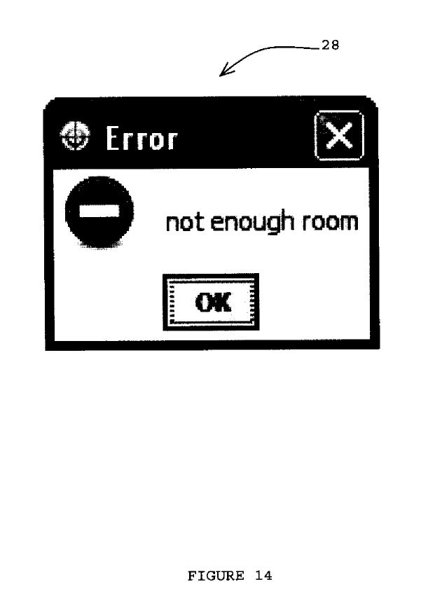

There may be gadget resize rules that incorporate: 1) Gadget can be made bigger or smaller; 2) If gadget is made smaller, the gadget will stay in the most upper-left cell it used to occupy; the freed-up cells will be filled with empty gadgets; 3) If gadget is made bigger, the “Resize” function will occur. FIG. 12 is a diagram where a selected gadget 24 of a screen 22 is resized from 2×2 to 1×2 in a screen 23. FIG. 13 is a diagram where a selected gadget 27 of a screen 25 is resized from 1×1 to 1×2 in a screen 26. FIG. 14 shows a screen 28 of a dialog when a gadget resize is not necessarily allowed.

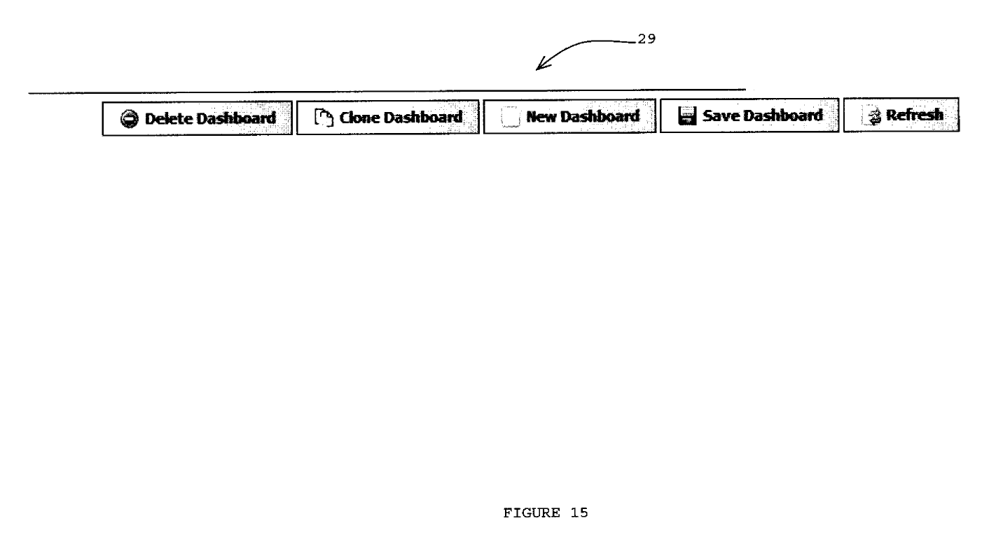

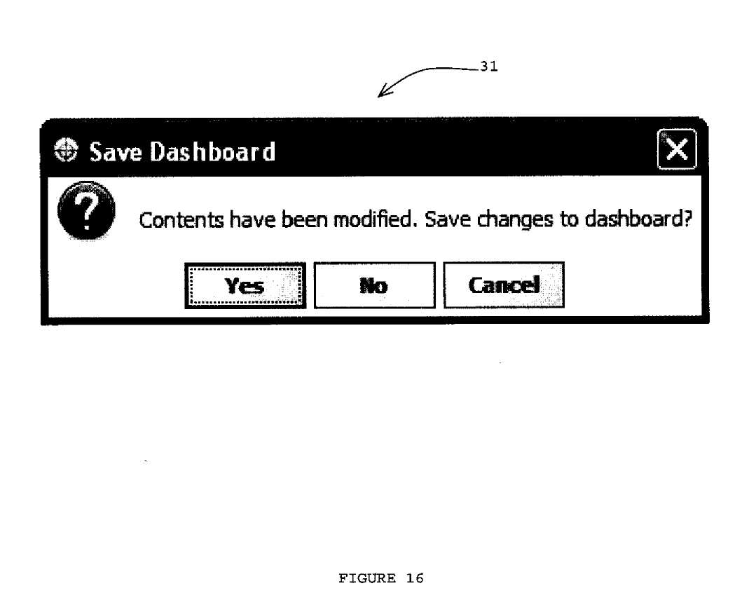

FIG. 15 is a screen 29 showing dashboard configurator command buttons for delete dashboard, close dashboard, new dashboard, save dashboard, and refresh. FIG. 16 is a diagram of a screen 31 showing a save dashboard reminder dialog.

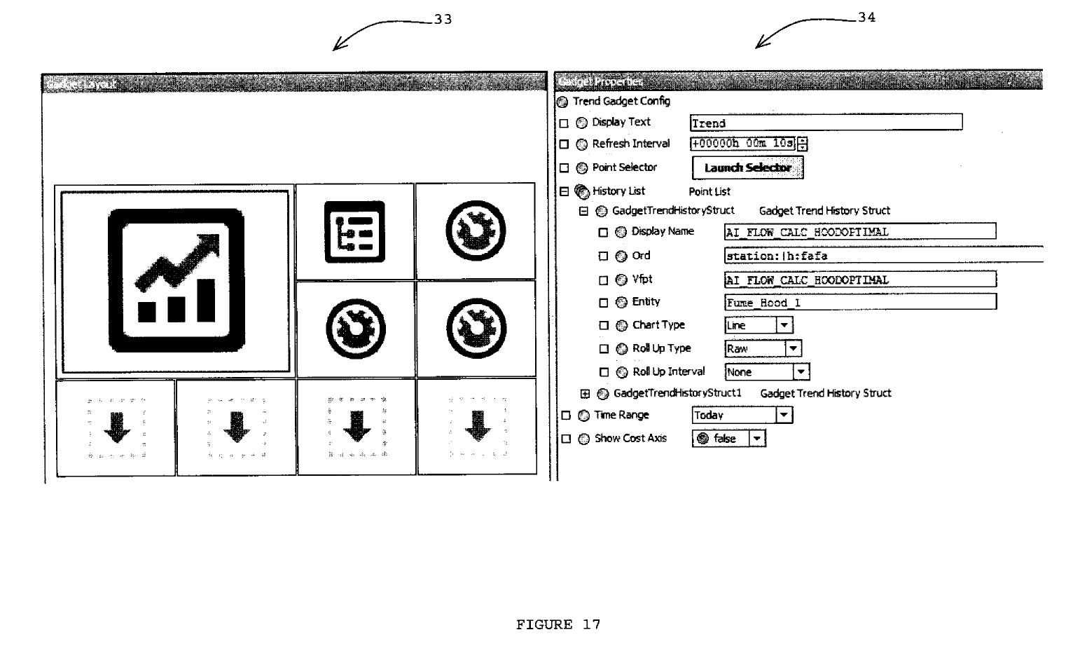

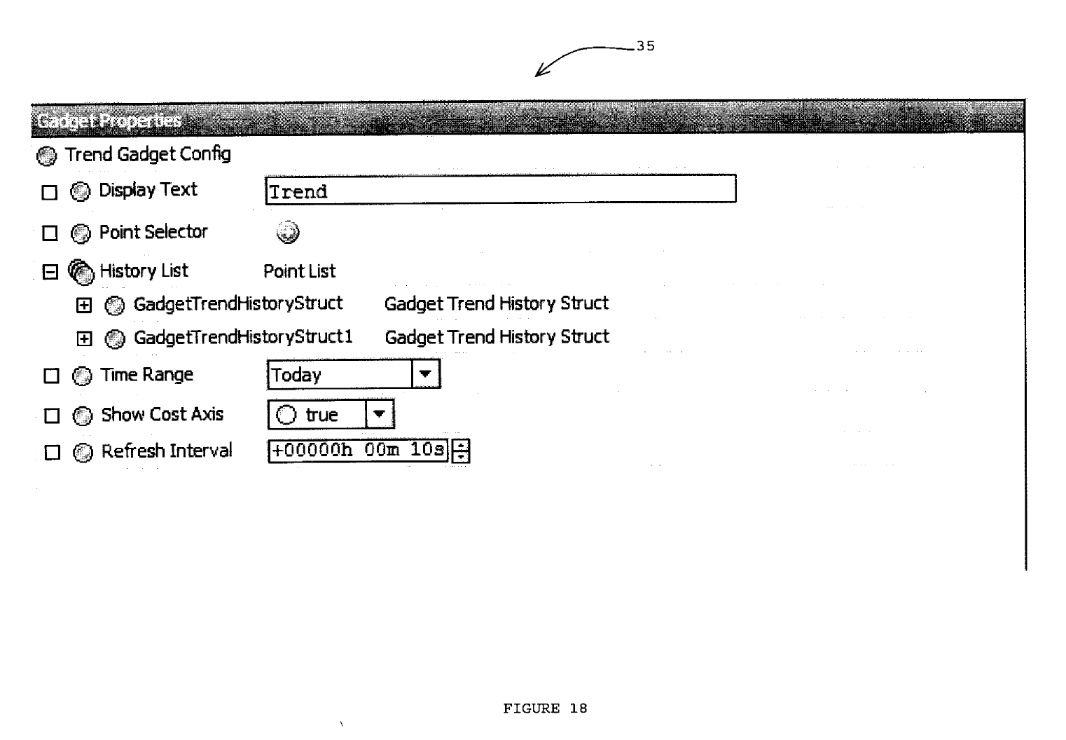

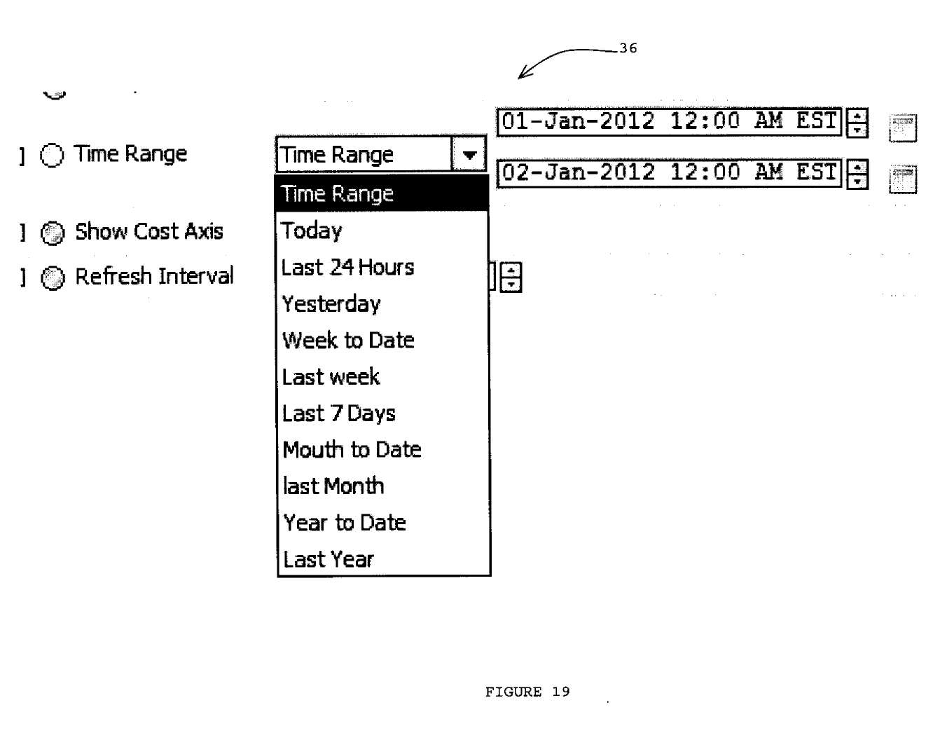

A variety of gadgets may be noted. FIG. 17 is a diagram of a screen 33 showing a designated gadget with a border around it and a corresponding screen 34 for gadget properties with entries for a trend gadget configuration. FIG. 18 is a diagram of a screen 35 for gadget properties where a point selector may be used to select up to eight points for live trend plotting. FIG. 19 is a diagram of a screen 36 portion of the gadget properties where a time range may be used to select a period of data to be trended.

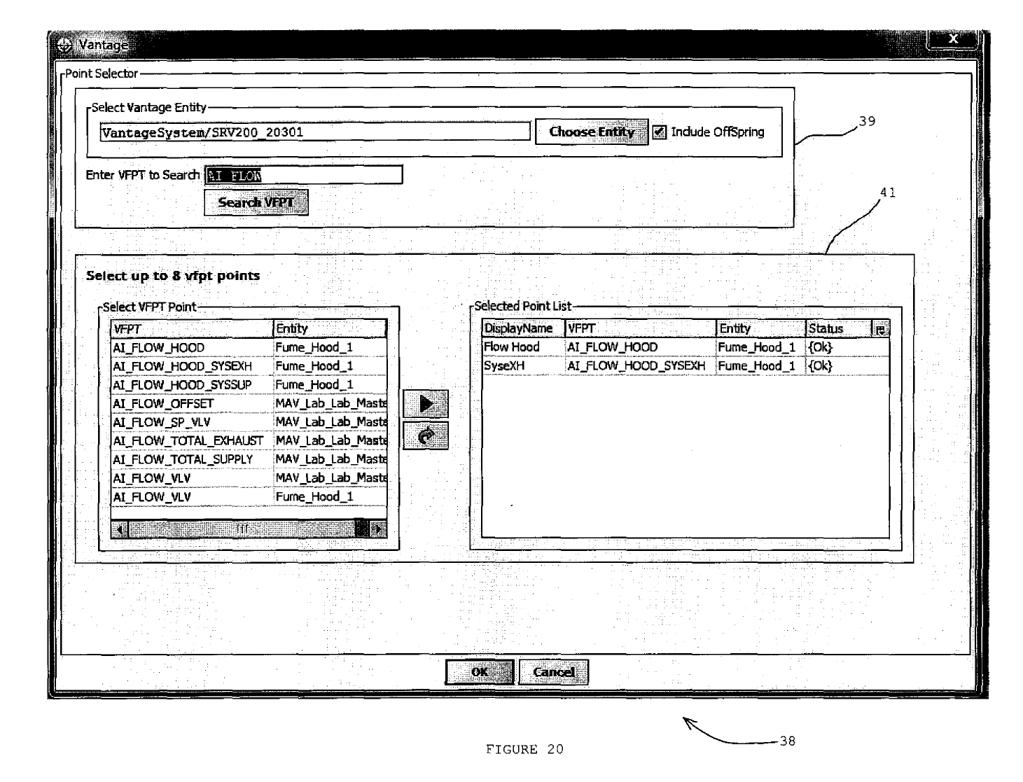

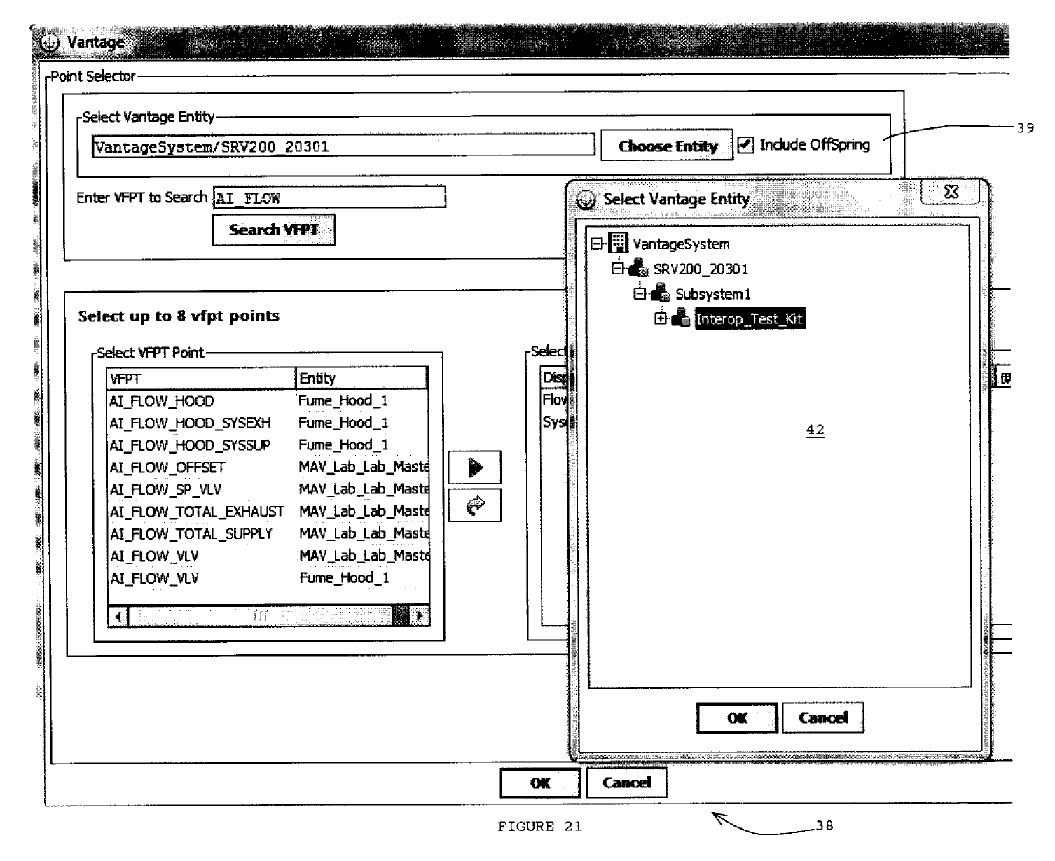

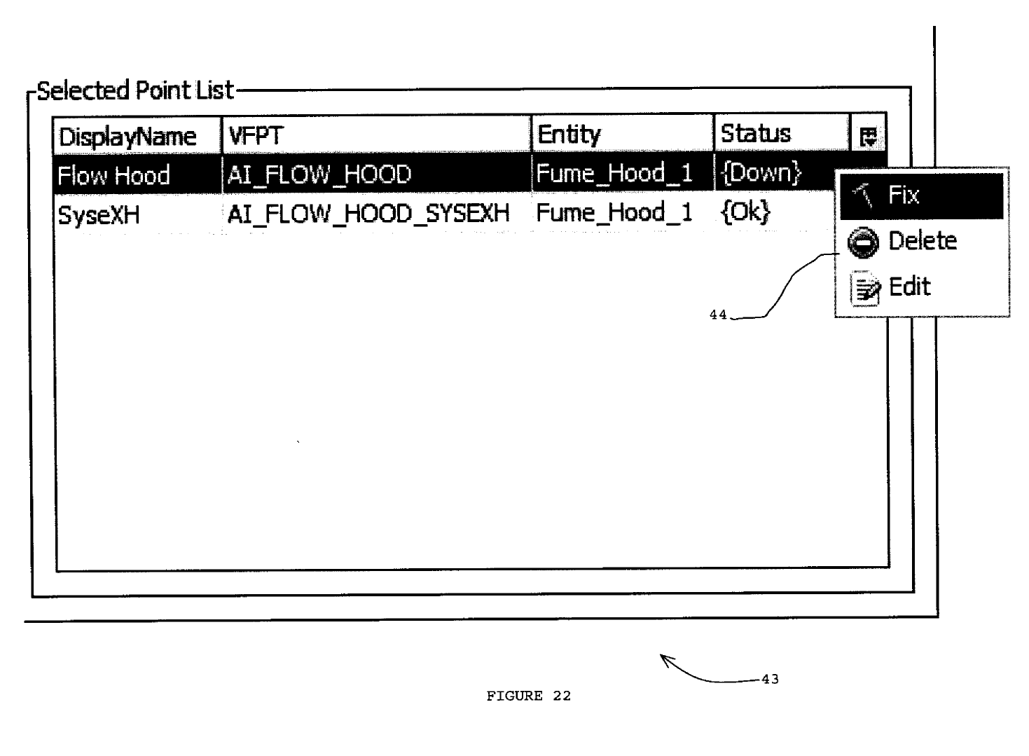

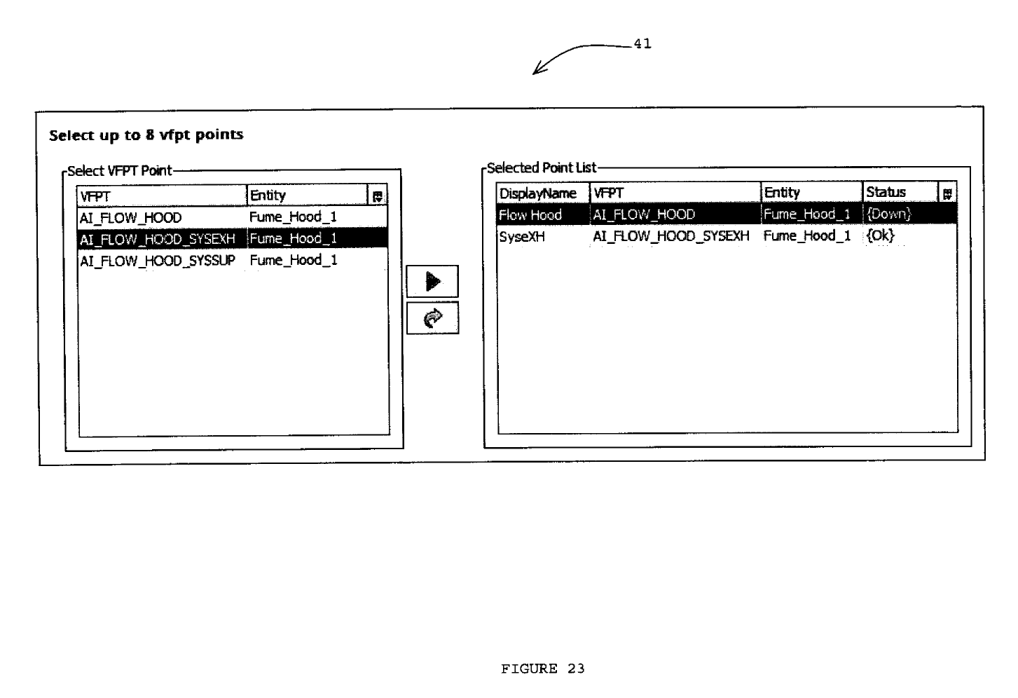

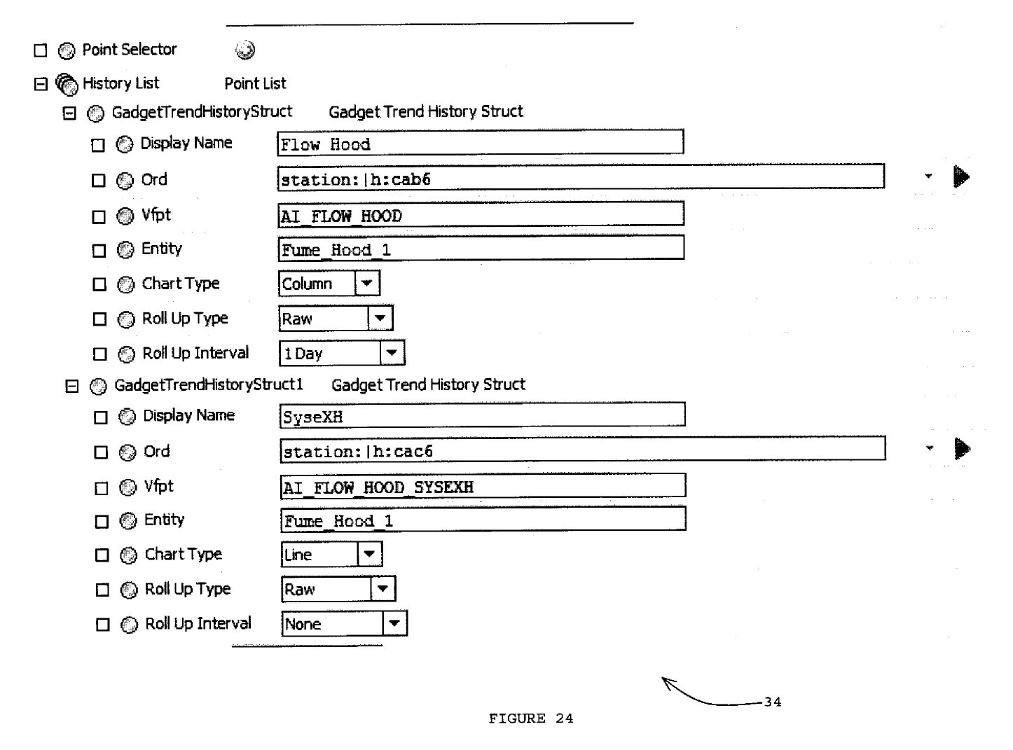

FIG. 20 is a diagram of a screen 38 showing a point selector view aka a launch selector. One may select an OffSping checkbox in area 39 to obtain all vfpt points in the offspring. The VFPT search option may be used to select the vfpt points. By default here the wild card characters are supported. Up to eight vfpt points may be selected in area 41. FIG. 21 is a diagram of screen 38 where one may use the Choose Entity button in area 39 to select an entity. Upon selection, all Vantage entities may be displayed in a tree 42 so that a user may select the desired entity. FIG. 22 is a diagram of a selected point list 43 that may have a fix option in a menu for fixing vfpt points if they are not valid, that is, if a control point is not mapped to a Vantage point. After selecting a fix, one may search for a new vfpt and add it to the vfpt to be fixed as shown in area 41 of a diagram in FIG. 23. Screen 34 in a diagram of FIG. 24 shows a result after virtually all of the valid configurations are done from the point selector.

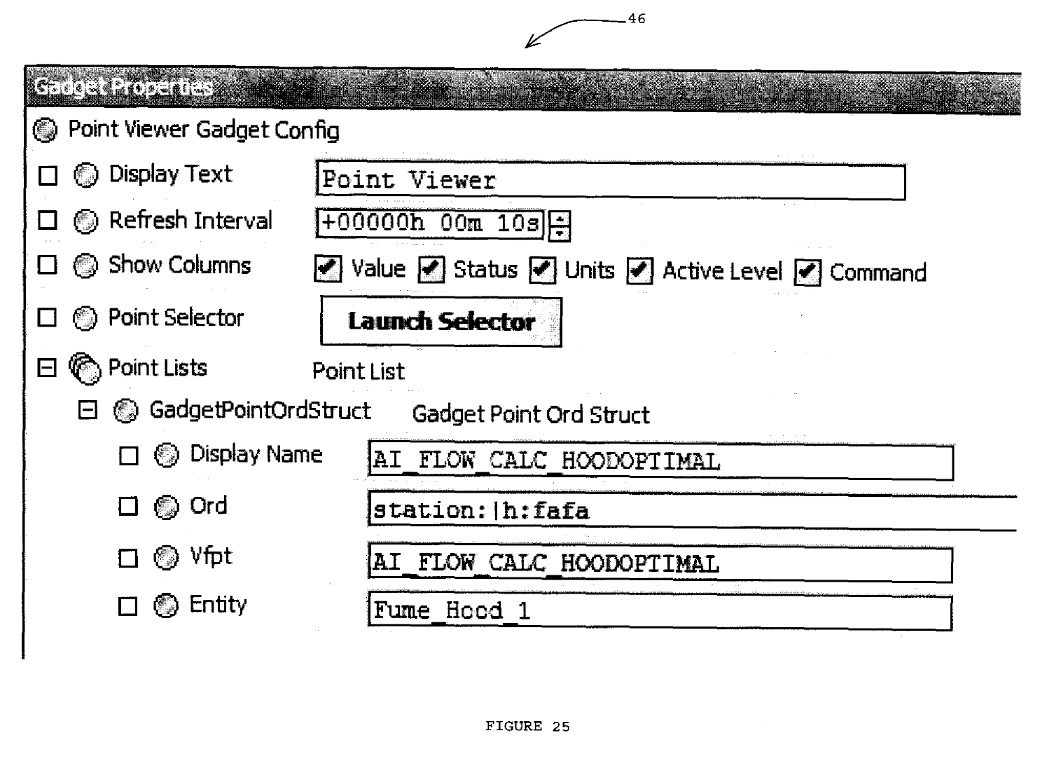

A point viewer gadget of a screen 46 of a diagram in FIG. 25 may allow a user to view a list of live Boolean or numeric points across a job. The point viewer gadget may be configured to display a list of real time values. The user may be able to add points by selecting the Point Selector button in screen 46. Points may be removed from a table by selecting the point to be removed and clicking on delete.

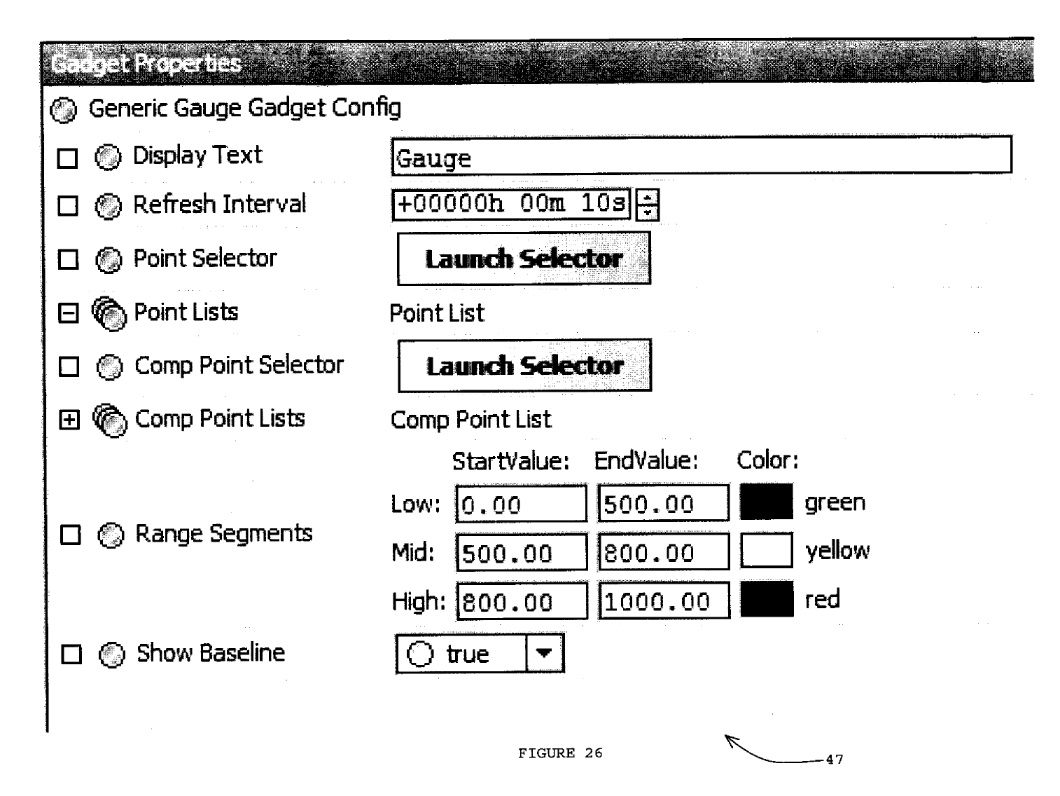

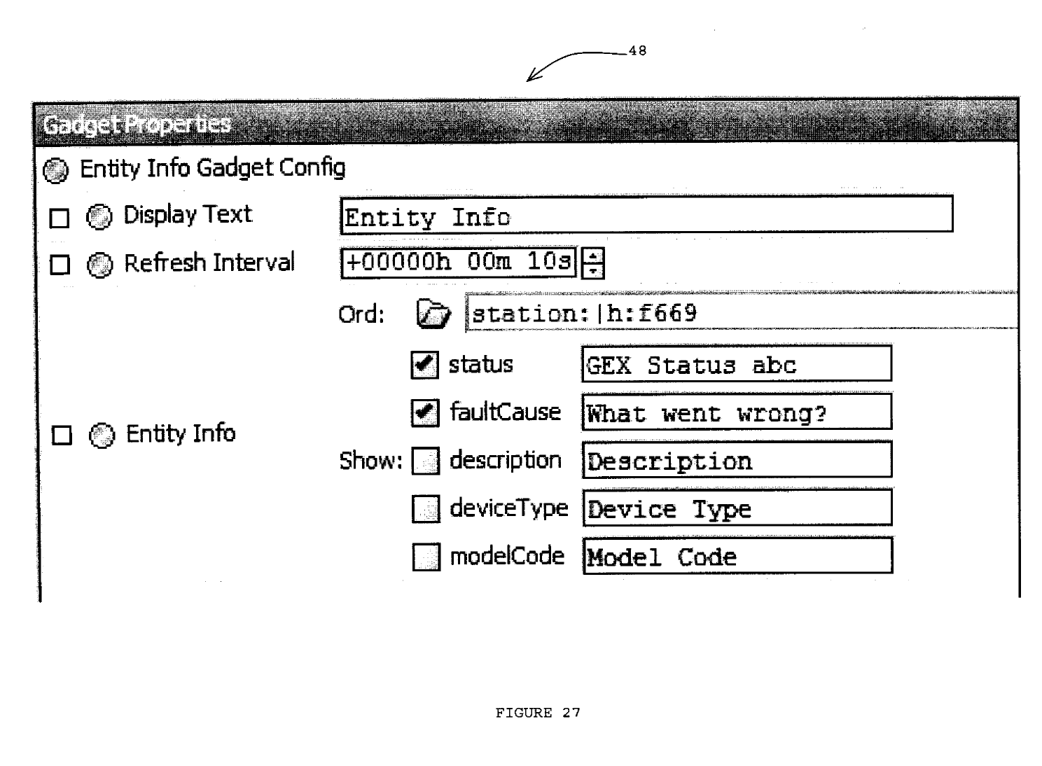

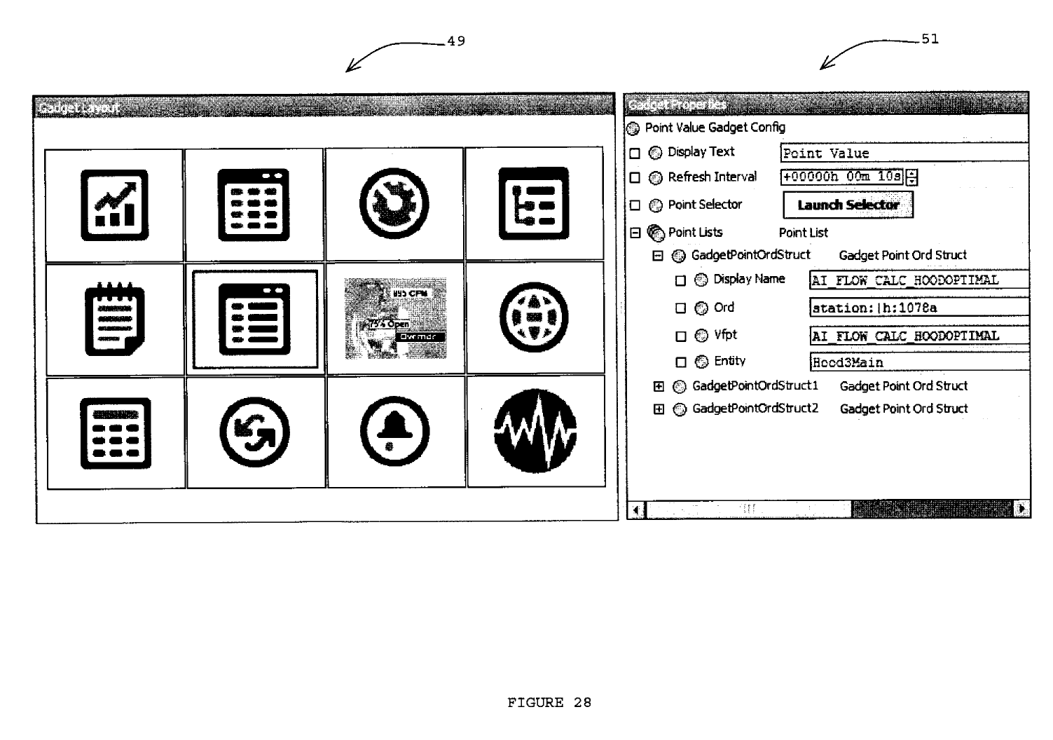

FIG. 26 is a diagram of a screen 47 for a gauge gadget. FIG. 27 is a diagram of screen 48 for an entity information gadget. FIG. 28 is a diagram of a screen 49 designating a point value gadget and a corresponding screen 51 for a point value configuration.

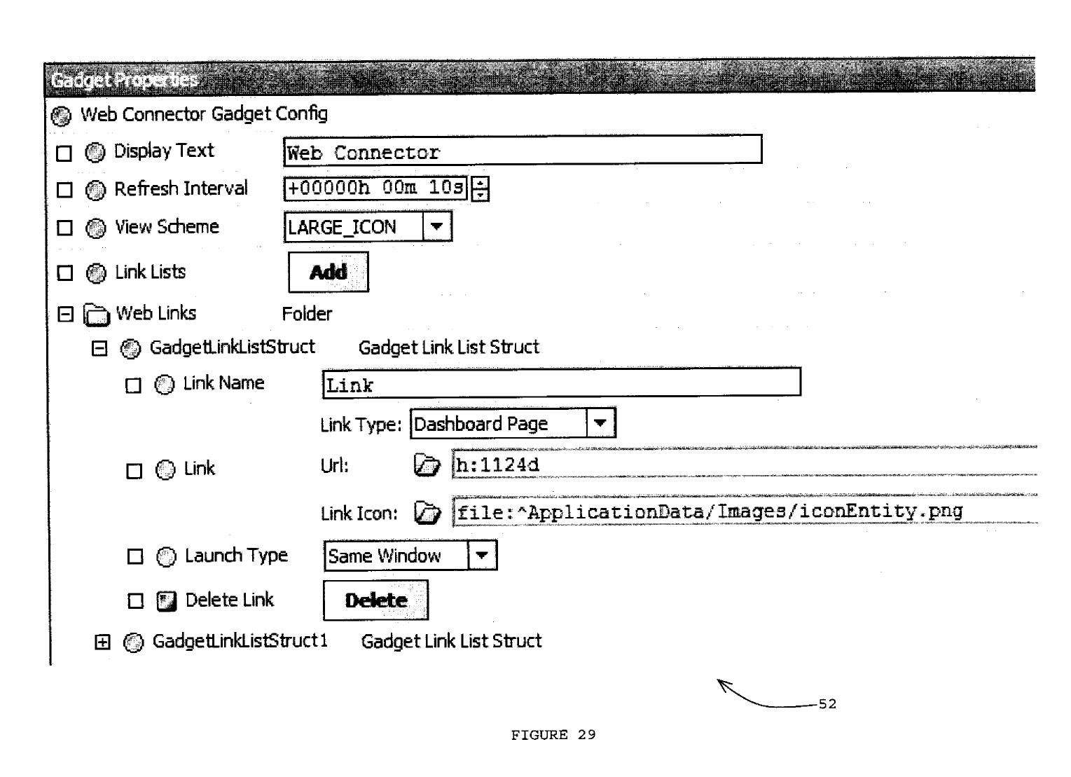

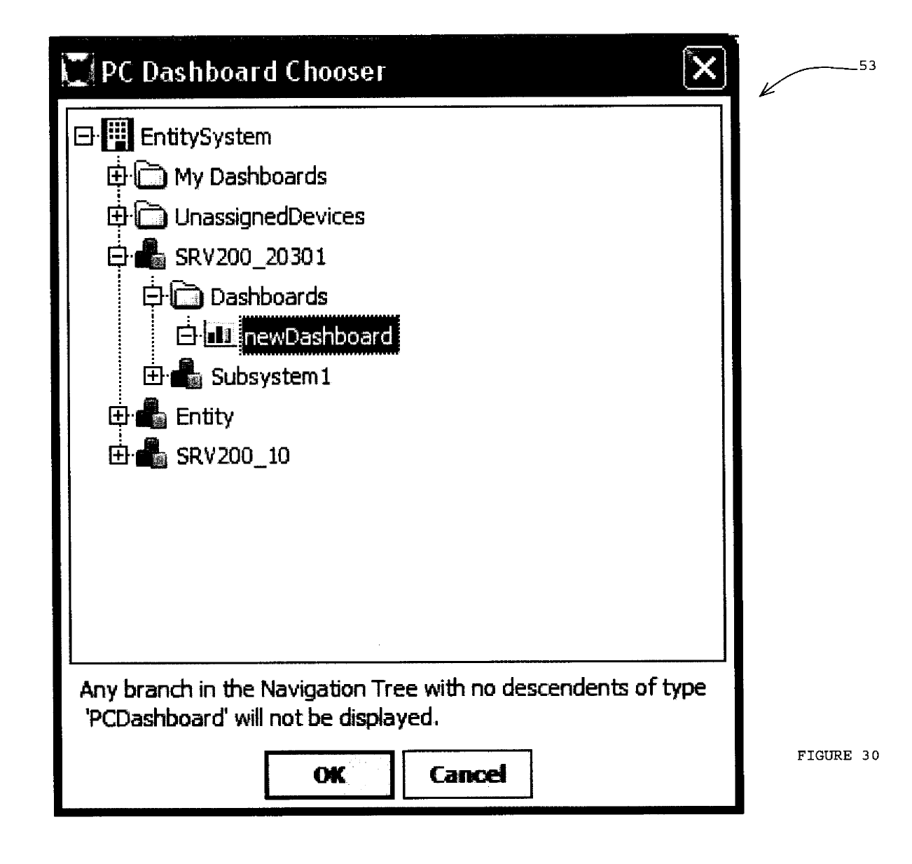

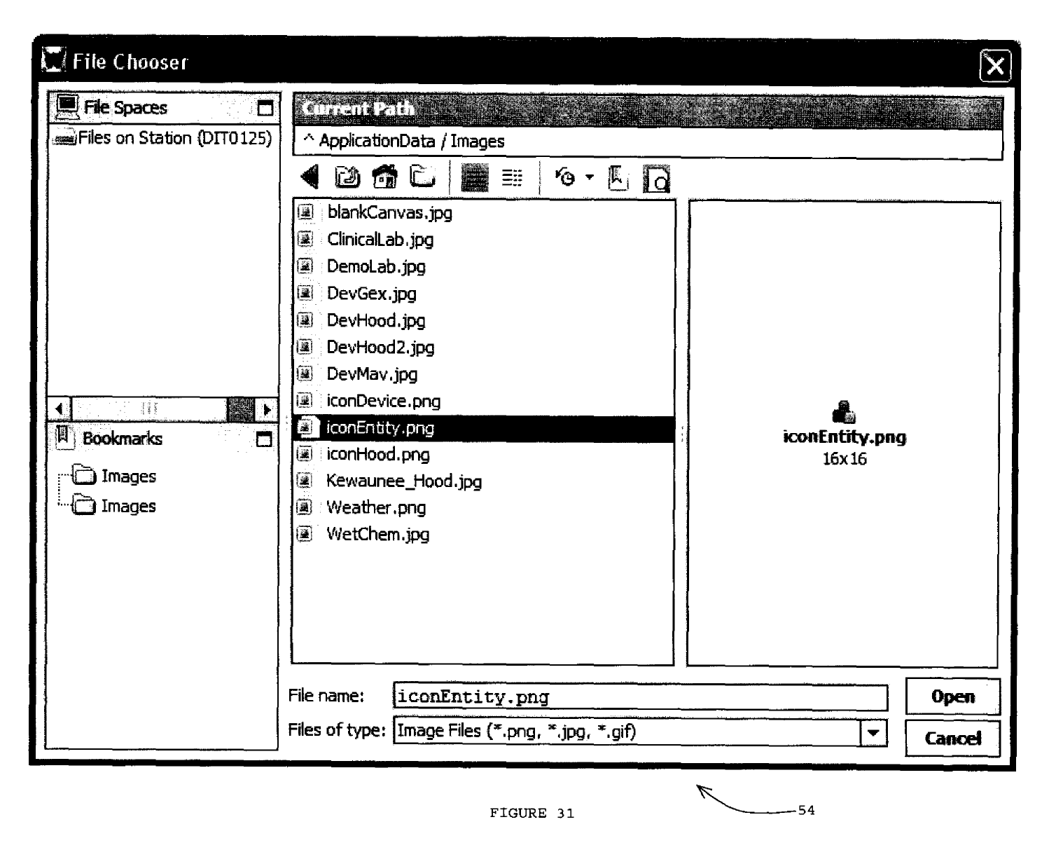

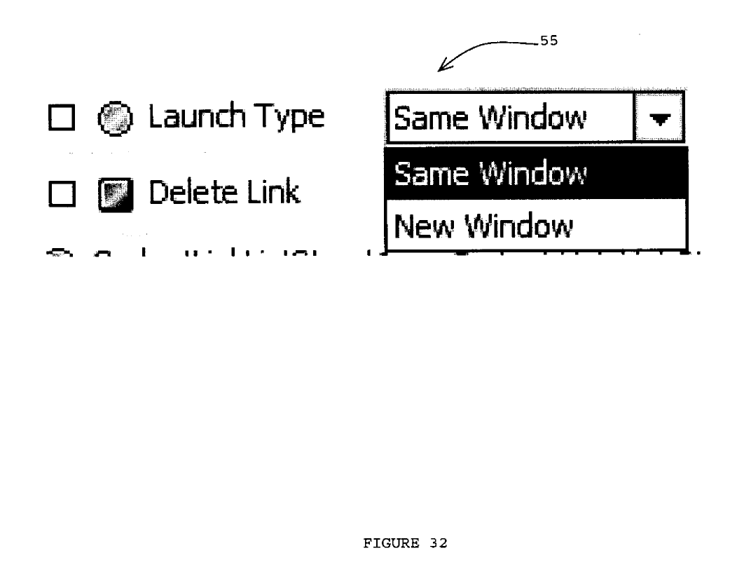

FIG. 29 is a diagram of a web connector gadget configuration screen 52. A web connector gadget may enable a user to connect to any internet or intranet web site and display a in a gadget window. The web connect gadget configuration may allow the user to enter a valid URL. To select a dashboard for a URL, one may press a folder icon for a URL in screen 52. One may select a dashboard component in “PC Dashboard Chooser” and then press the “OK” button shown in screen 53 of a diagram in FIG. 30. By default, “iconEntity.png” may be chosen as an icon image in screen 54 of a diagram of FIG. 31. A user may select a different icon file from an “ApplicationData/Images” folder in screen 54. A new URL may be launched in the same tab, a new tab or a new window as shown in a screen 55 in a diagram of FIG. 32.

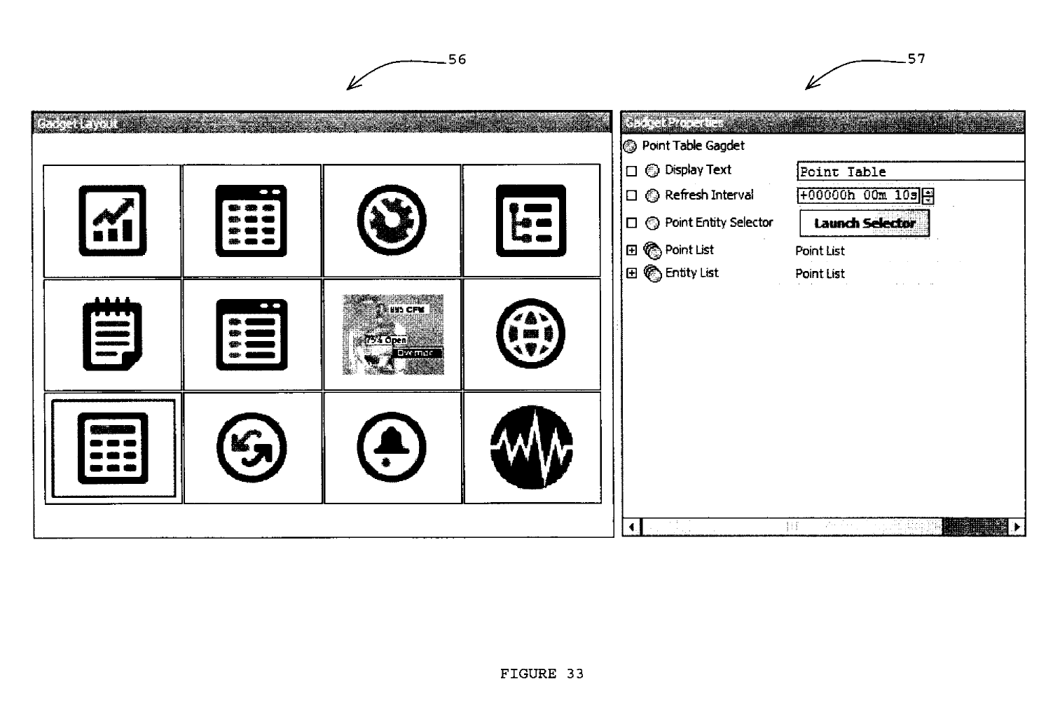

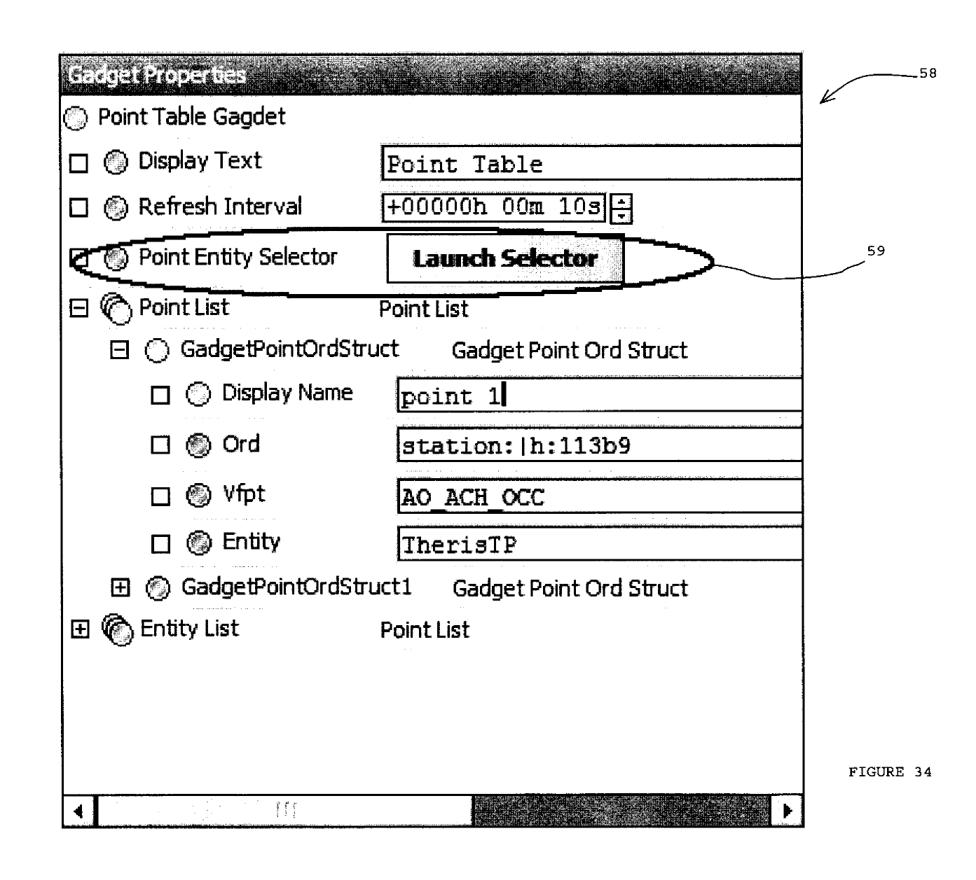

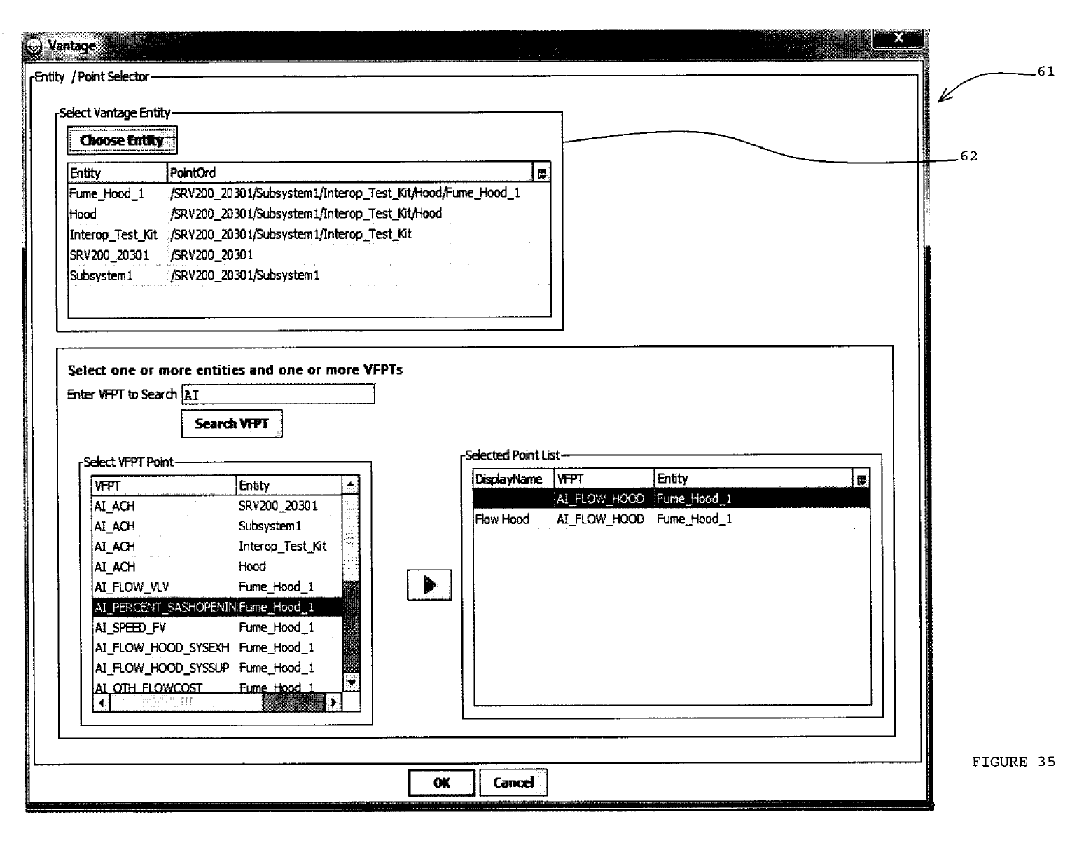

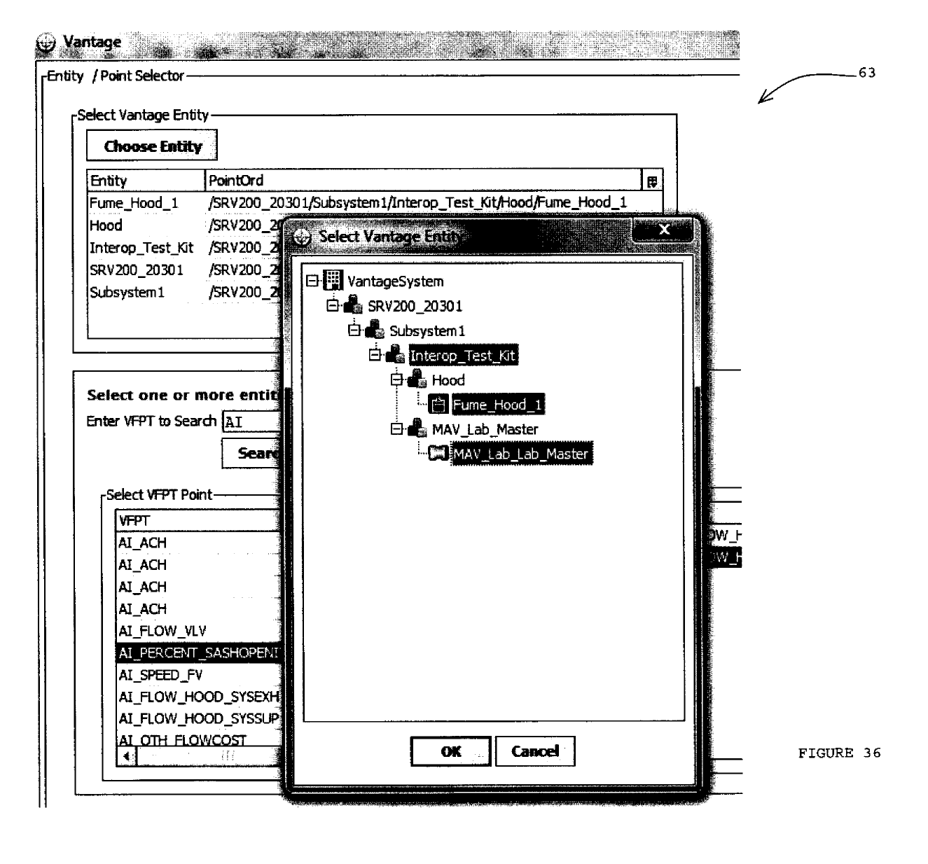

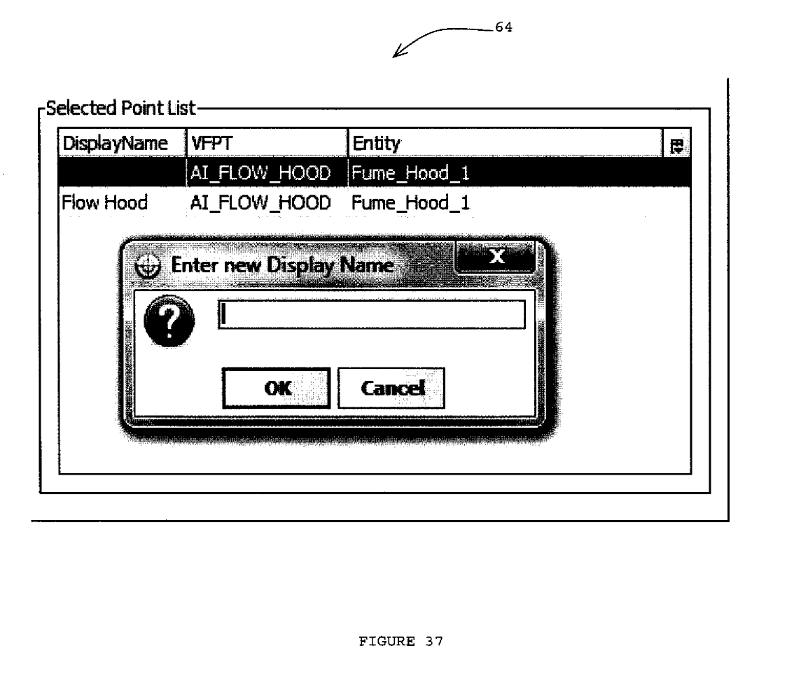

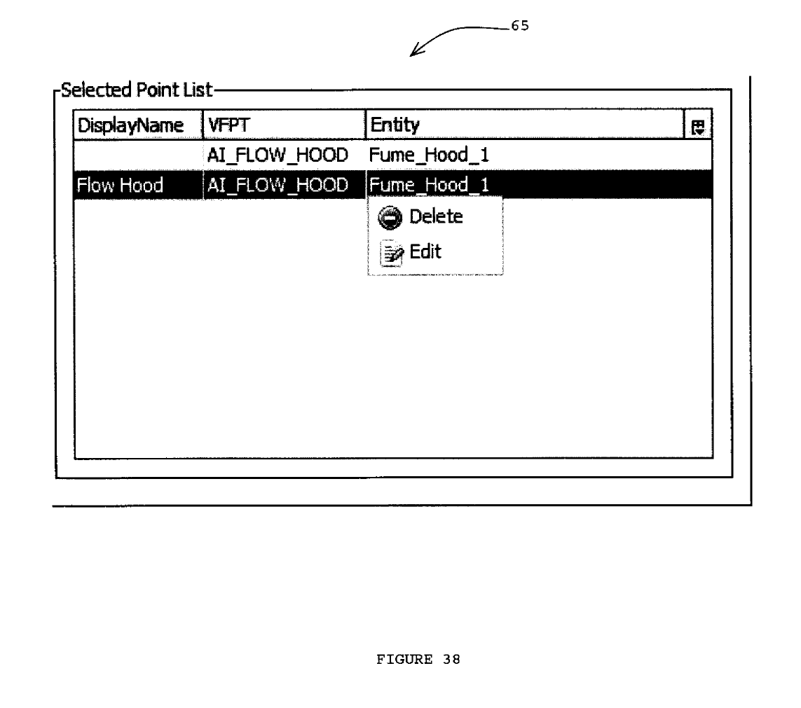

FIG. 33 is a diagram of a gadget screen 56 for selection of a point value gadget and a corresponding screen 57 for point value properties. One may press a launch selector button 59 of screen 58 in a diagram of FIG. 34 to get a point entity selector as shown in a screen 61 of a diagram of FIG. 35. A new entity may be selected by pressing the choose entity button of an area 62 of screen 61. A multi-selection may be permitted for entities that are allowed shown in a screen 63 of in a diagram of FIG. 36. One may double-click a vfpt row to enter a new display name for right-click the vfpt and select to edit the name as shown in screen 64 of a diagram in FIG. 37. To delete a vfpt, one may right-click the vfpt point and select delete as shown in a screen 65 of a diagram in FIG. 38. Just a single selection may be enabled.

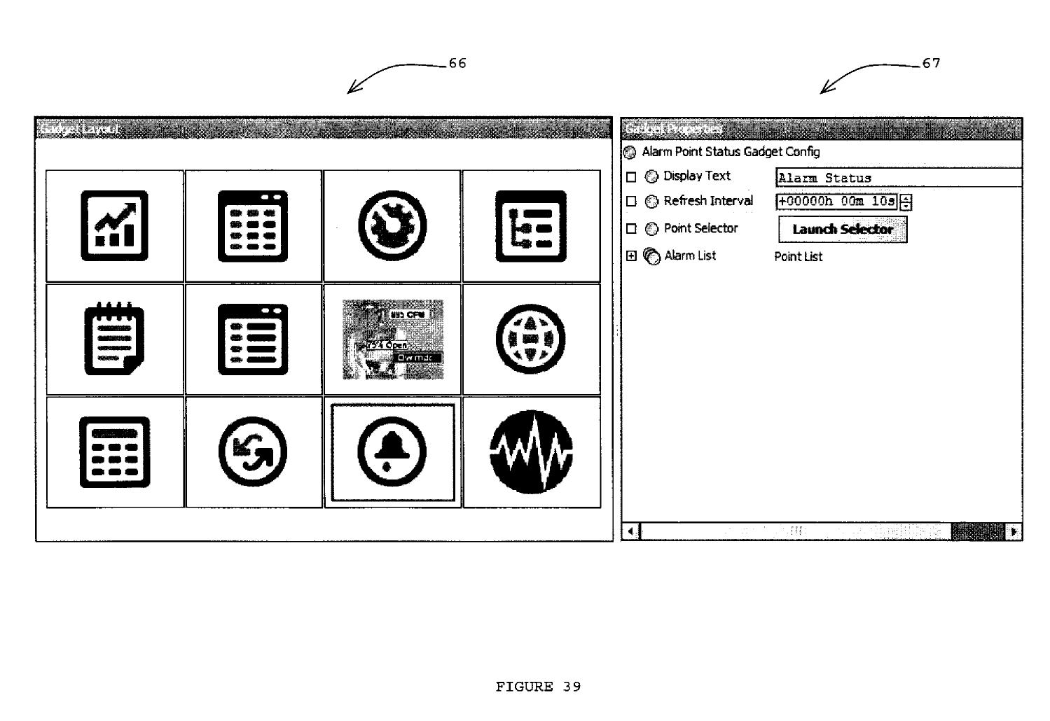

An alarm gadget selection in a screen 66 and an alarm point status gadget configuration in a corresponding screen 67 are shown in a diagram of FIG. 39. One may use a launch selector in screen 67 to configure Boolean points.

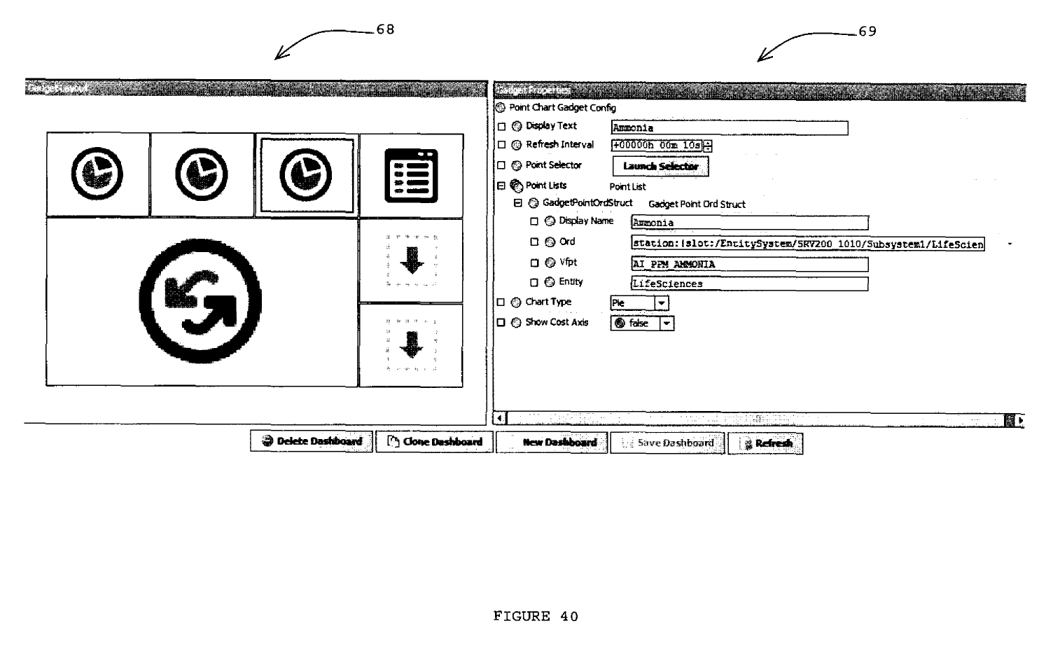

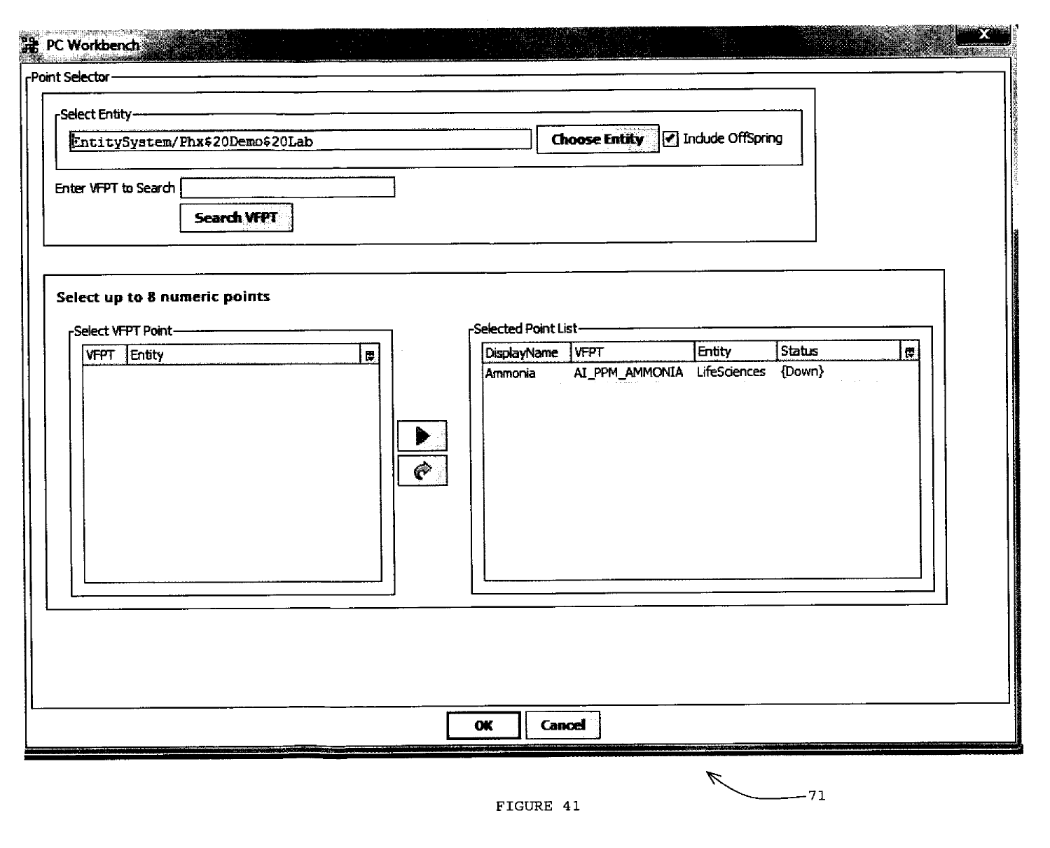

A point chart gadget selection in a screen 68 and a point chart gadget configuration in a corresponding screen 69 are shown in a diagram of FIG. 40. One may use a launch selector in screen 69 to configure numeric points. Screen 69 may be used to display the log in two forms of charts, that is, column and pie charts. A screen 71 of a diagram in FIG. 41 shows a point selector where one may select an entity and up to eight numeric points. The present design may permit virtually any number of numeric points.

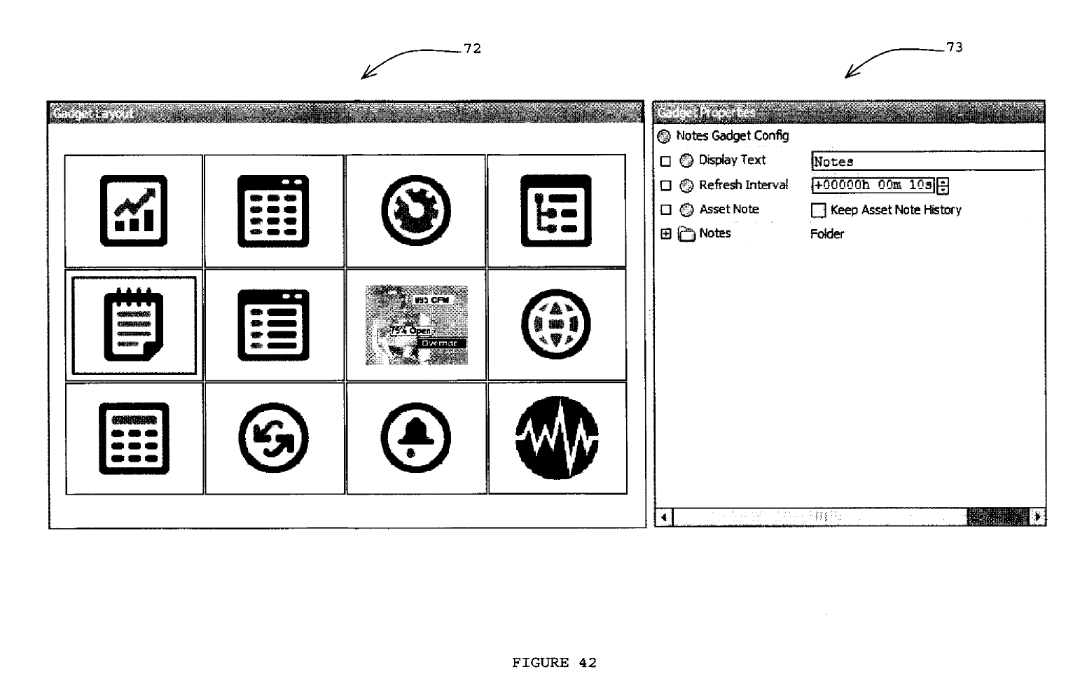

A notes gadget that may be selected in a screen 72 and referred to relative to a notes gadget configuration in a corresponding screen 73 of a diagram in FIG. 42. The notes gadget may be used in a web dashboard to add Unicode language, can be support by a browser. Notes cannot necessarily be edited by a workbench dashboard configurator. To keep an asset history of previous notes, one may select a check box of “Keep Asset Note History” in screen 73.

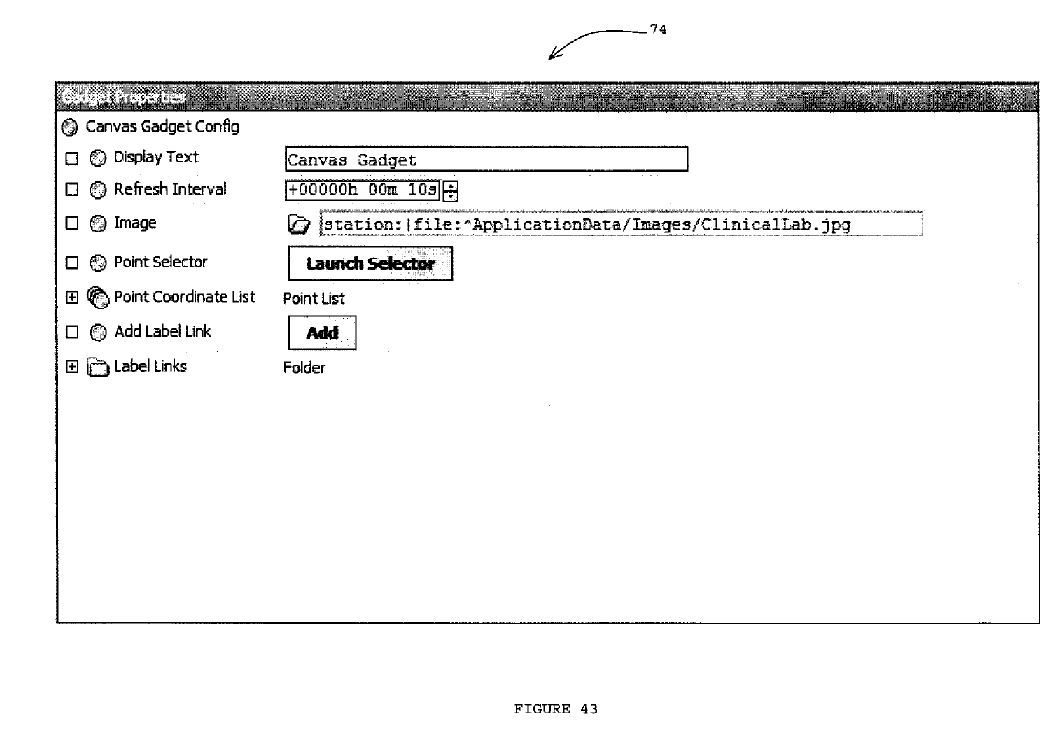

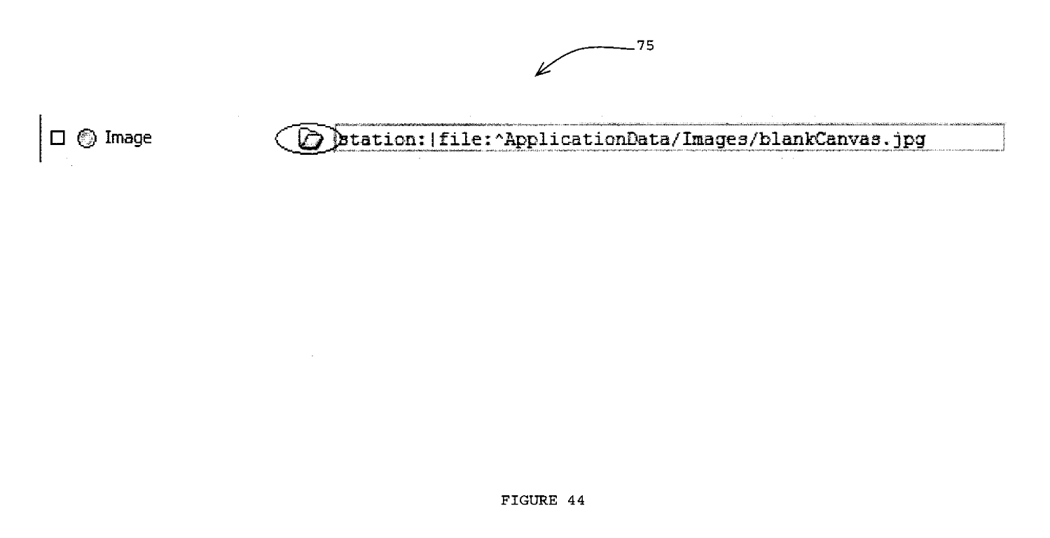

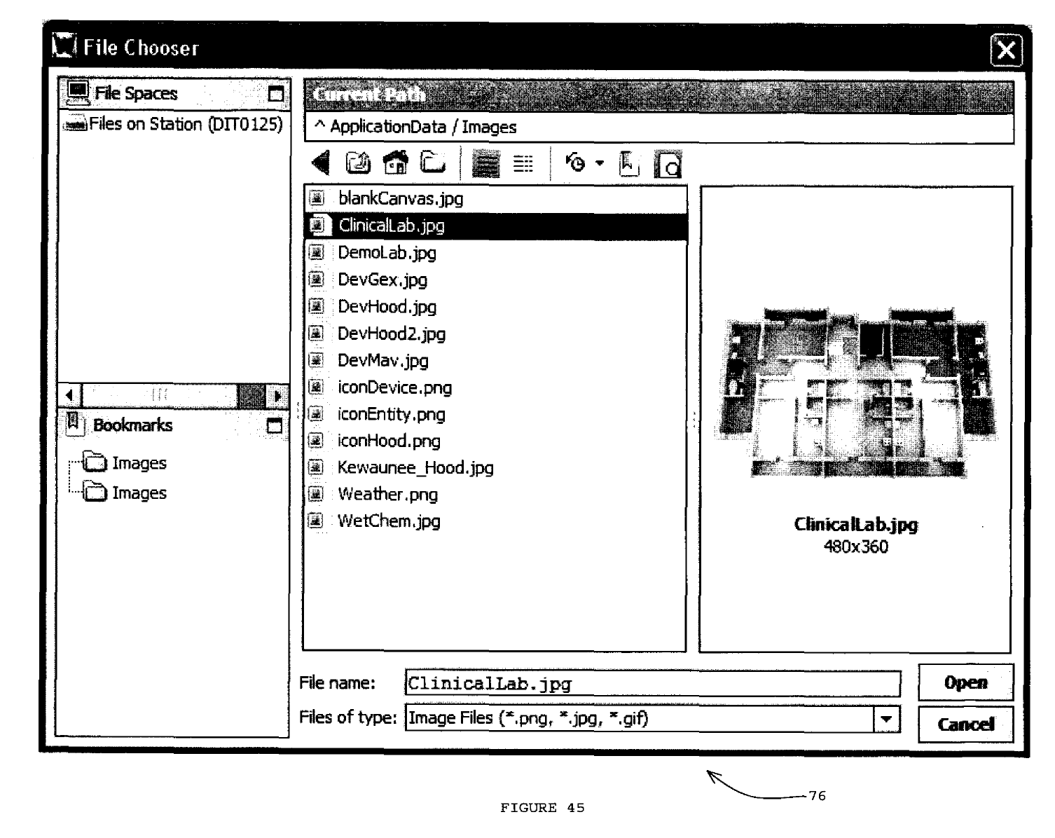

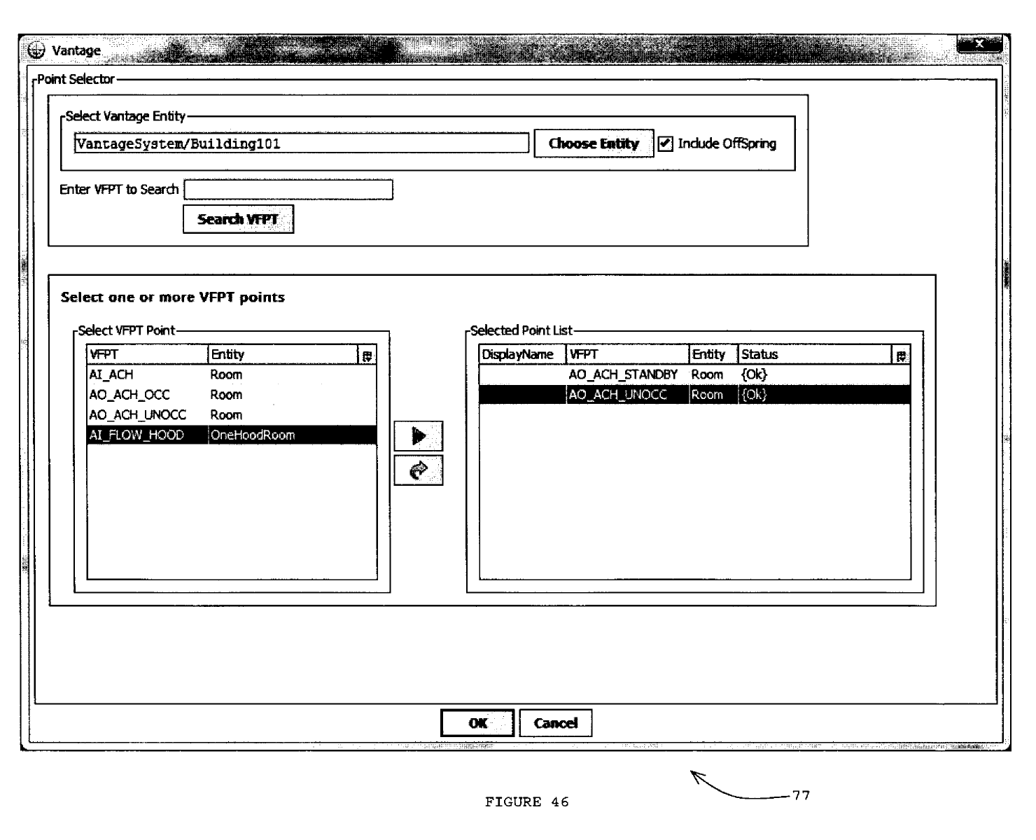

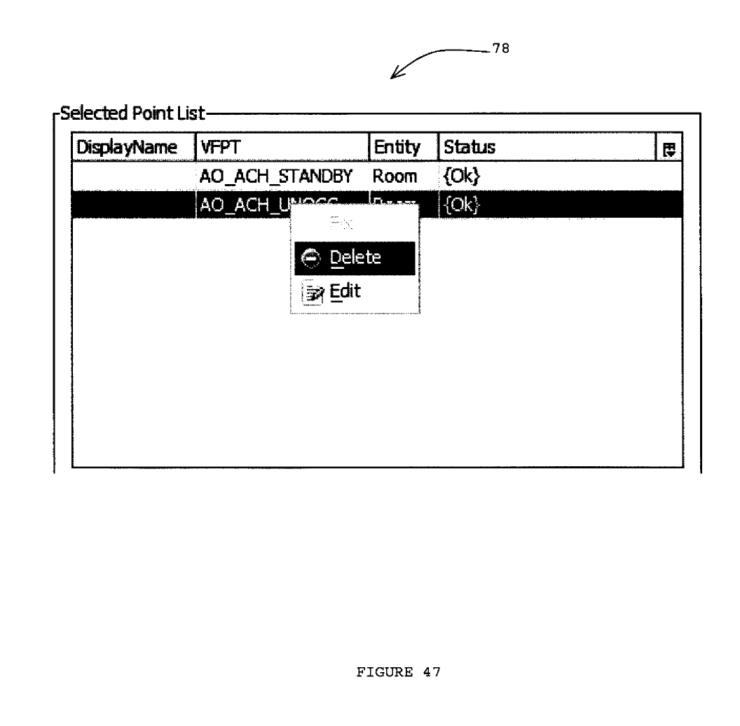

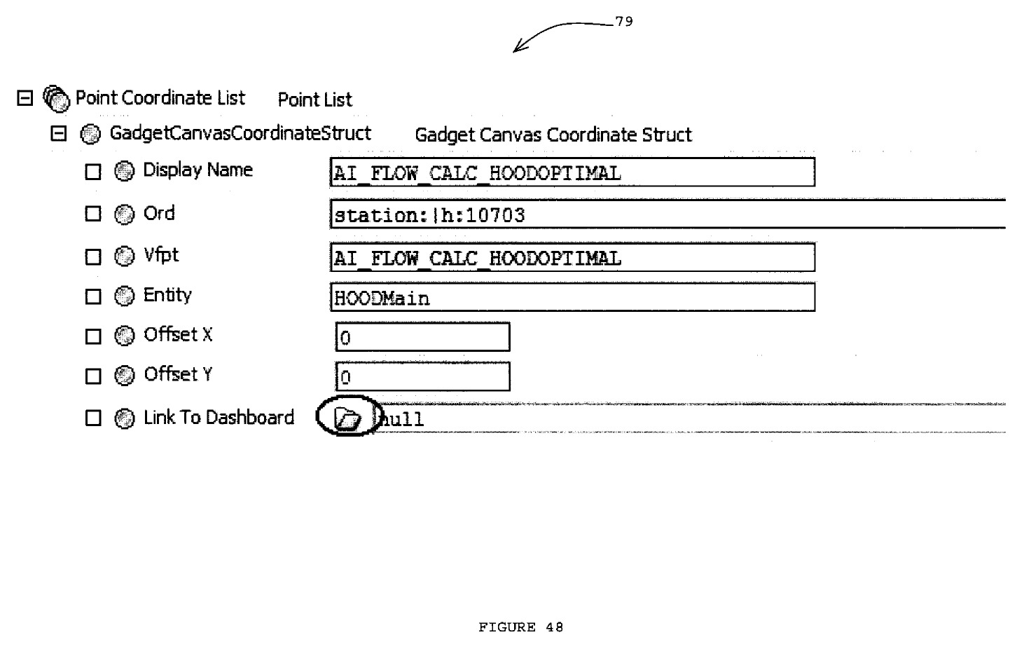

A diagram in FIG. 43 shows a canvas gadget configuration screen 74. A purpose of the canvas gadget is to display a background picture or image overlaid with point values. The values may act as hyperlinks to other locations. The background may be chosen by clicking an “Image” slot's folder icon in screen 75 of a diagram of FIG. 44, and launching an image file Ord chooser. Just image files in “ApplicationData/Images” folder may be allowed. An example image is shown at the right portion of a screen 76 in a diagram of FIG. 45. Each point may be created by clicking a point selector button “Launch Selector” in screen 74, which launches a point selector tool in a screen 77 of a diagram in FIG. 46. One or more points may be chosen. Points may also be removed or edited from the point selector tool by right-clicking on the point list as shown in a screen 78 of a diagram in FIG. 47. Editing may set the display name. The points may then be listed under the “Point Coordinate List” in a screen 79 of a diagram in FIG. 48, and can be opened to expose details. The Ord and VFPT may be set automatically by the point selector tool. Entity may also set automatically, which is only used to help a user in performing a configuration to distinguish points of the same name. Entity information is not necessarily seen by an end user. The X and Y coordinates may be entered as a percentage (and precision is integer), between 0 and 100. In this way, if the gauge is resized, then locations may move accordingly. A link may also be set so that if the user clicks on the value, it will send them to a different address (page, and so on). A refresh interval may have a minimum of five seconds. Smaller values may cause an error when attempting to save the gauge.

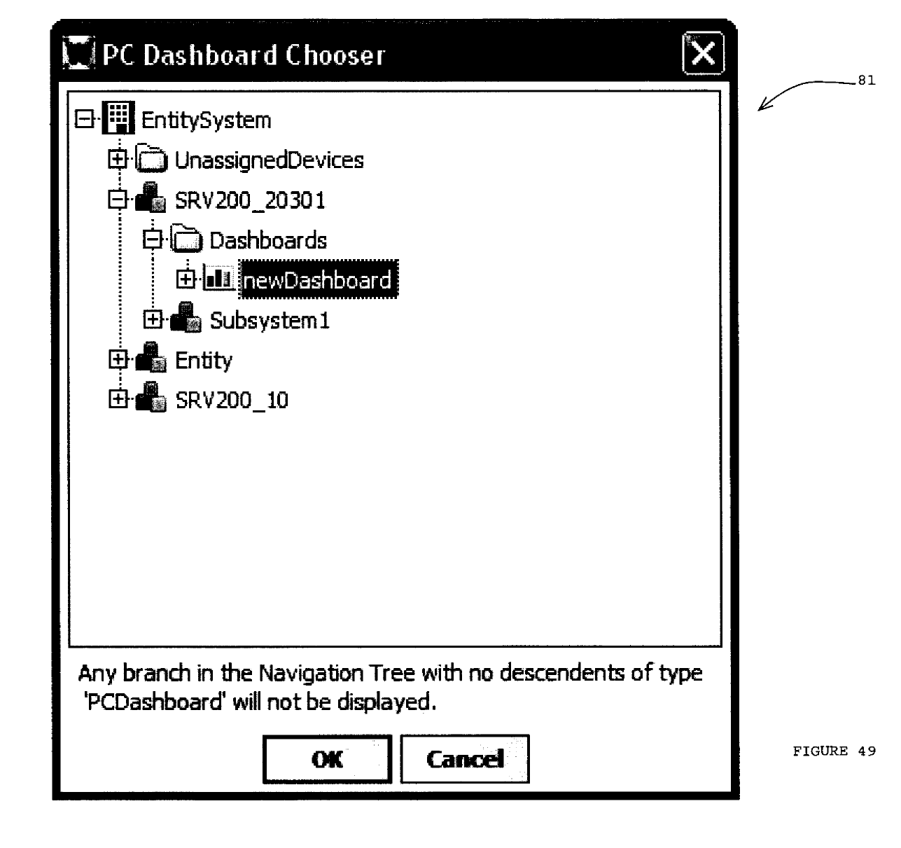

A screen 81 of a diagram in FIG. 49 shows PC dashboard chooser. Any branch in a navigation tree with no descendents will not necessarily be displayed.

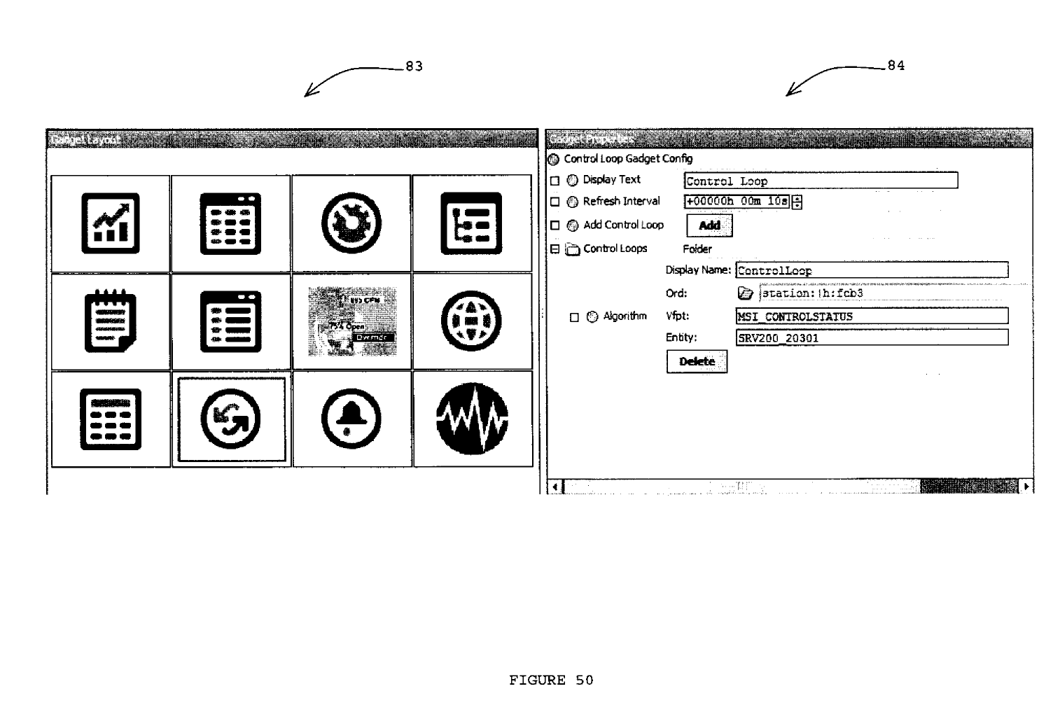

FIG. 50 is a diagram of a screen 83 of gadgets and a corresponding screen 84 of a control loop gadget configuration for a selected control loop gadget in screen 83. A purpose of the control loop gadget may be to track a set point and feedback of multiple point values. Each pair of set point-feedbacks may be considered a “Control Loop”. Each control loop may also have settings for a warning band and an alarm band, which can be entered as a percentage of the set point value. For example, a warning level of “5 percent” indicates a band from set point minus 5 percent to set point plus 5 percent.

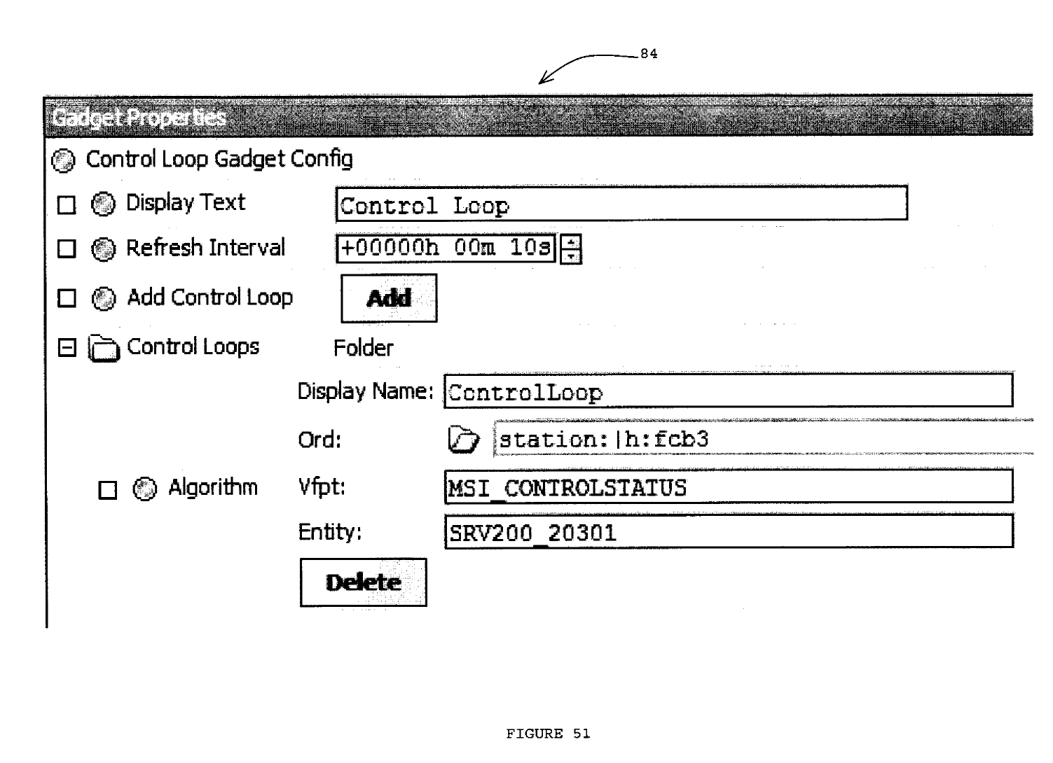

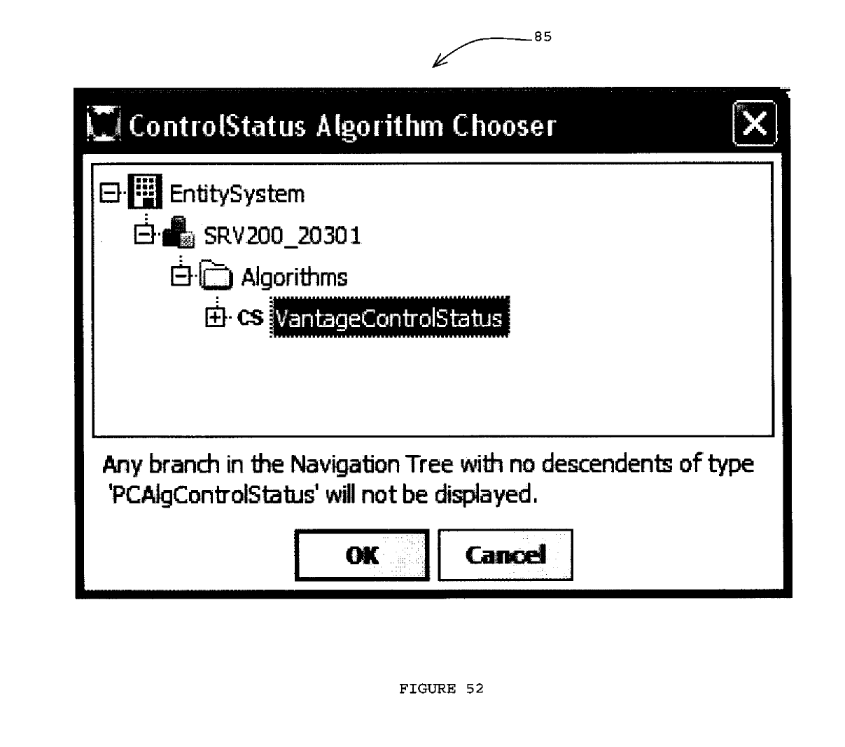

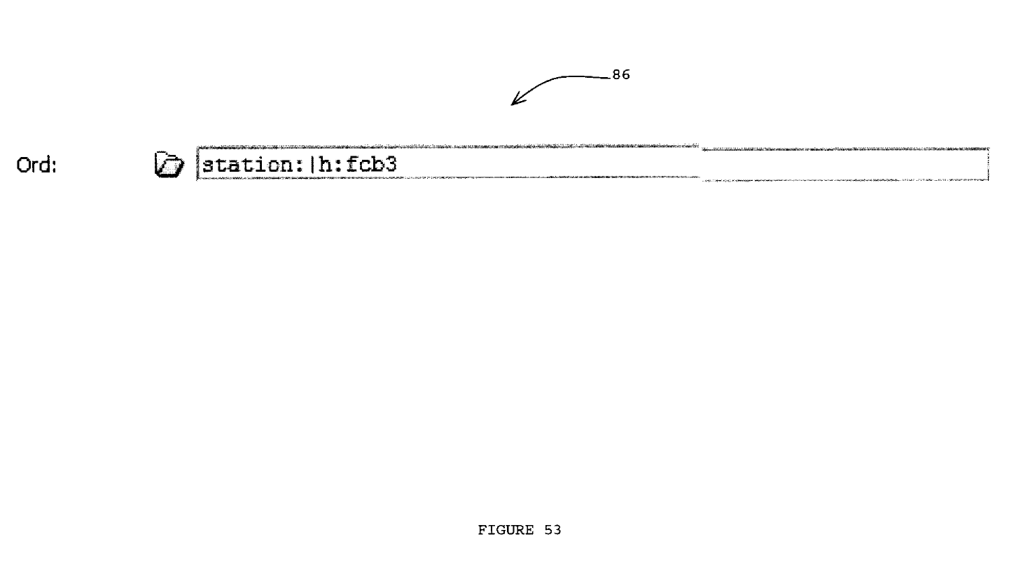

Each control loop may be created by clicking the “Add Control Loop” button, which may add a new control loop under the “Control Loops” folder, as shown an enlargement of screen 84 in a diagram of FIG. 51. An example shows five (5) loops created. An expand [+] icon may be clicked to open each control loop and edit the details. To delete a control loop, a delete button may be pressed for that loop. For instance, an algorithm type may be supported. To select a BVantageControlStatus algorithm component as an input, a “folder” icon may be pressed to open an “Algorithm Chooser” dialog box, as shown in a screen 85 of a diagram in FIG. 52. Any branch of the navigation tree with no descendants of a type “PCAlgConrolStatus” will not necessarily be displayed. One may select an algorithm component and press OK. A component Ord, as indicated in a screen 86 of a diagram in FIG. 53, may be populated in an “Ord” field. The point selector tool may also be available as an option. Another type of a control loop may be a point data source type. One may select “points” from a data source pull down. In this type of loop, four properties (Set Point, Feedback point, Warning Level %, Alarm Level %) may each be set individually. There may be additional properties.

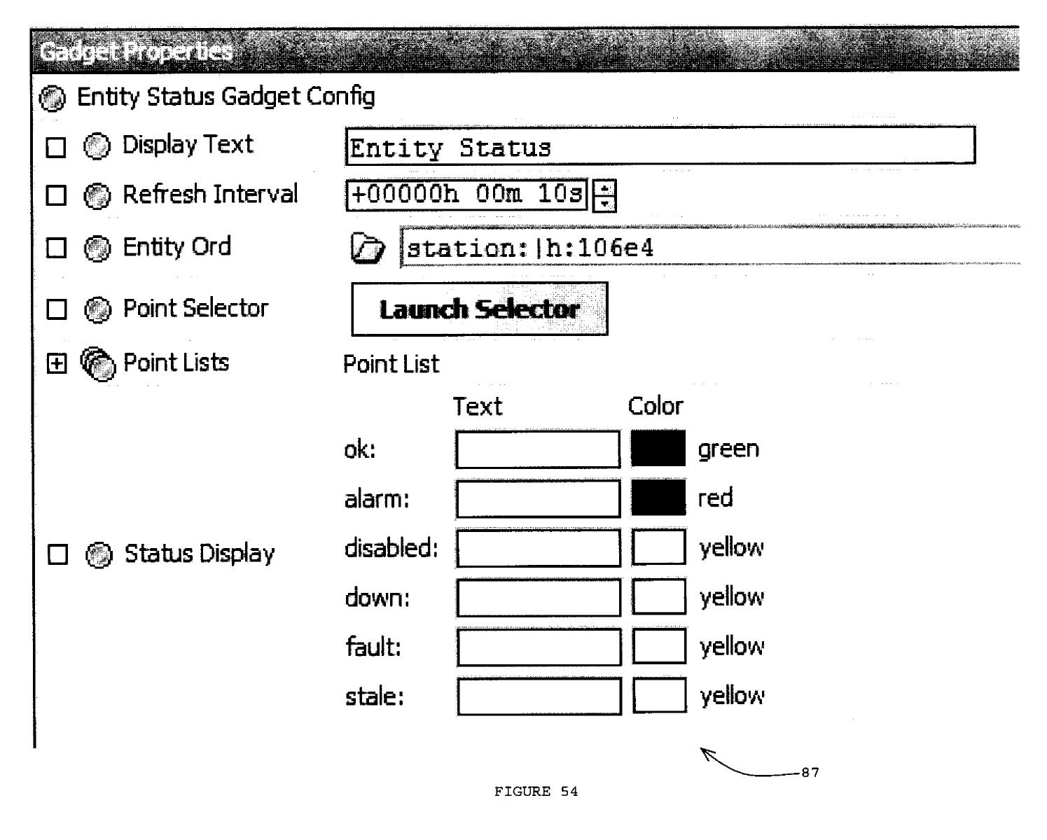

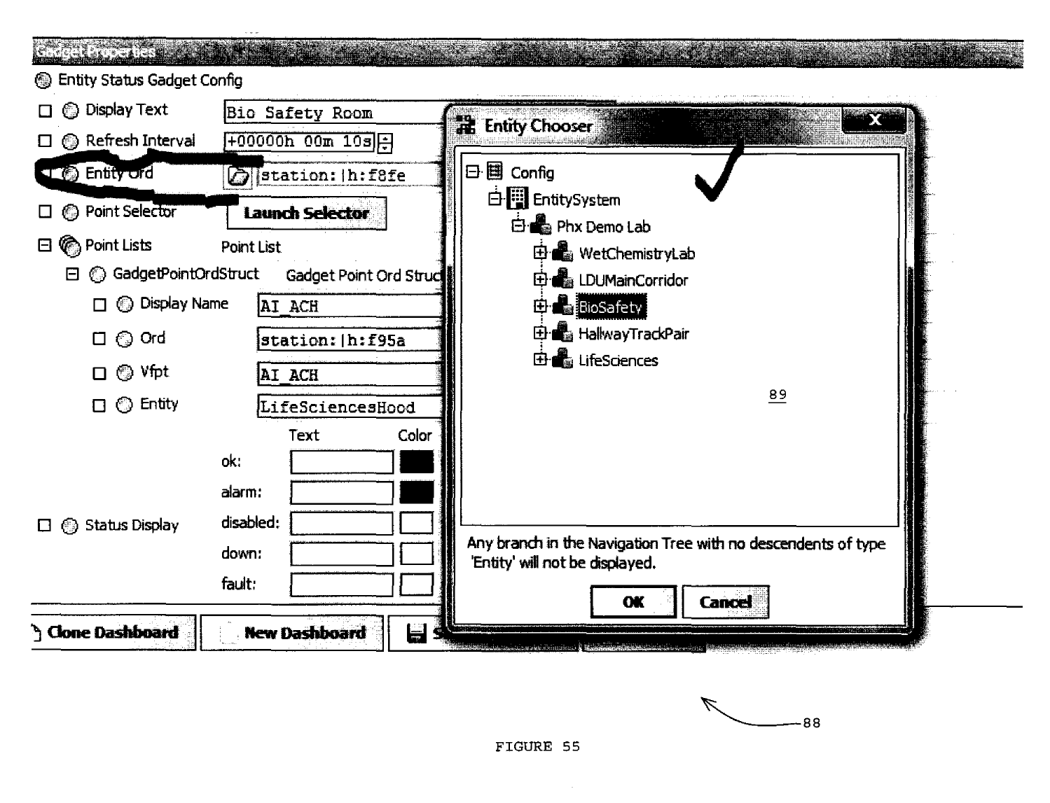

FIG. 54 is a diagram of a screen 87 of an entity status gadget configuration. An Entity Ord may be used to select or let the a user decide which entity is to be navigated once the user hyperlinks to a top level entity. A screen 88 of a diagram in FIG. 55 may show an entity chooser 89. Any branch in a navigation tree with no descendents of type “Entity” will not necessarily be displayed.

There may be systems and approaches for easy configuration, monitoring and management of control points spread across multiple devices and entity in a Niagara devices network. The Tridium™ Niagara AX framework may be a base software application to develop an entity point manager that appears significant herein. A feature may capture improvements made to the Niagara point manager user interface application to provide a customer the desired user experience in creating and deploying job configurations to the site controllers.

A Phoenix technician may need a single unified view where she or he can view virtually all of the Phoenix control points (aka Vantage points) and identify to which entity it has been mapped. An entity may be a building, floor, room or even a device. A Phoenix user may want a customized view she or he can identify the Vantage points that have been associated to certain dashboard. The user may want to manage a history trend for multiple vantage points at the same time and specify a history size and a roll out policy. The user may also want to trend multiple history points to a database from the same unified view (aka PC point manager view).

Niagara framework may be improved to provide the following features, such as a unified view to map the control points the associated entity, a unified view to map the control points the associated dashboards, a centralized tool to manage related functions such as history and trend them in a single view and for multiple points, since multiple steps are time consuming for a Phoenix user, and a view for monitoring multiple control points from multiple networks.

The present approach may provide a user an ability to create a logical, hierarchal structure representing her or his business and entity structure. A solution may be to provide the user a friendly, streamlined experience to create and deploy his or her job configurations. A unified and customized Vantage point manager may be provided for an entity or entity system.

The view may be available in a dropdown menu of a Vantage entity. In the view, just Vantage points may be managed. In other words, if a control point is not mapped to a Vantage Point, it will not necessarily be shown.

With the unified Vantage point view, a Phoenix user may reorganize the control points in the system by logical rather than physical components in the system. Virtually all of the points, regardless of their physical presence in the system, may be viewed, monitored and managed using logical entities in the building. There may be a single view to manage multiple vantage points and a trending. There may be a unified view for archiving multiple vantage points. A Vantage point manager view may support a mapping of vantage points to a corresponding entity and mapped dashboards. Building points may be easily managed across a network. Configure time may be reduced.

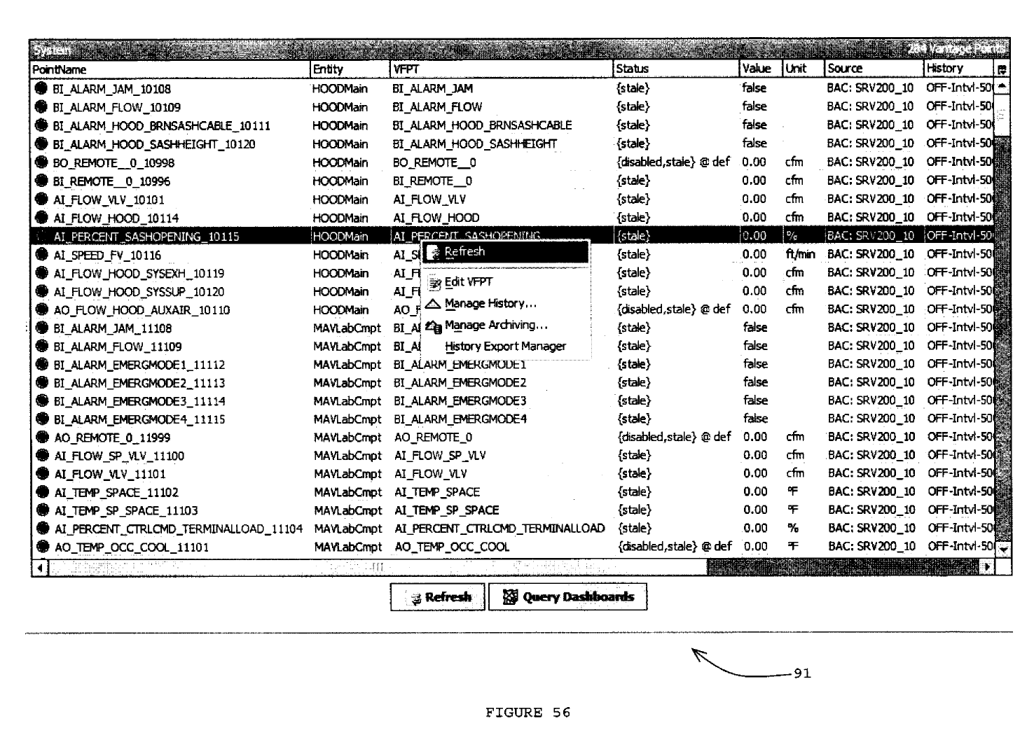

A screen 91 of a diagram of FIG. 56 shows a list of points with point names, entity, VFPT, status, value, unit if any, source and history.

The following steps describe how this new application will solve the problem as stated in the previous section. To avoid virtually all issues, a user may perform the following steps. The user may create an entity hierarchy of, for example, a building, floor, room, and device. The user may map Vantage points to an entity. The user may right-click and -select any of part of the entity (building, floor, room, device, and so forth) from where she or he wants to manage the vantage points. If the user wants a view from the descendant level (e.g., device), the user may view them and just those Vantage points will be displayed. A right-click menu for any point may be used to access manage history, manage archiving, and history export manager screens. Just two columns may have editable cells, that is, VFPT and Out of Service. Right-click menus in these columns may launch an input for changing either the VFPT family and type, or for setting a point to out of service. A query dashboard button can be used to see a Vantage points mapping with respect to the dashboards.

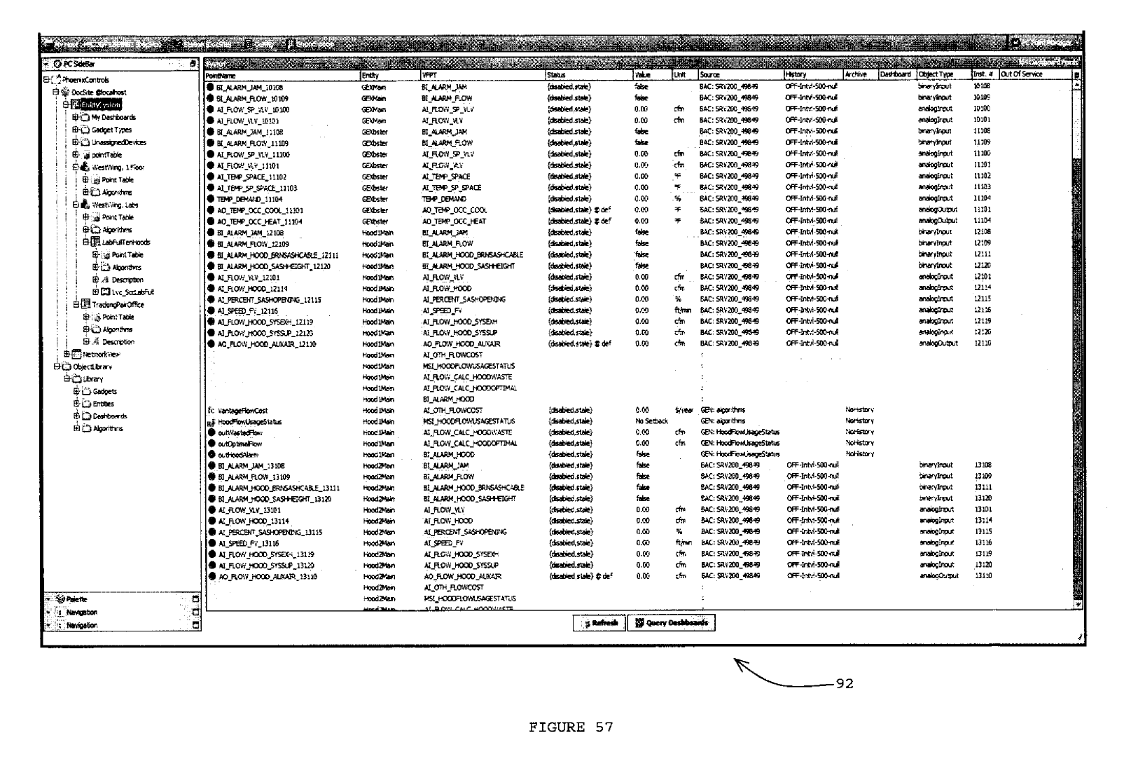

A screen 92 of a diagram of FIG. 57 shows a list of points with point names, entity, VFPT, status, value, unit if any, source, history, archive, dashboard, object type, Inst. #, and out of service.

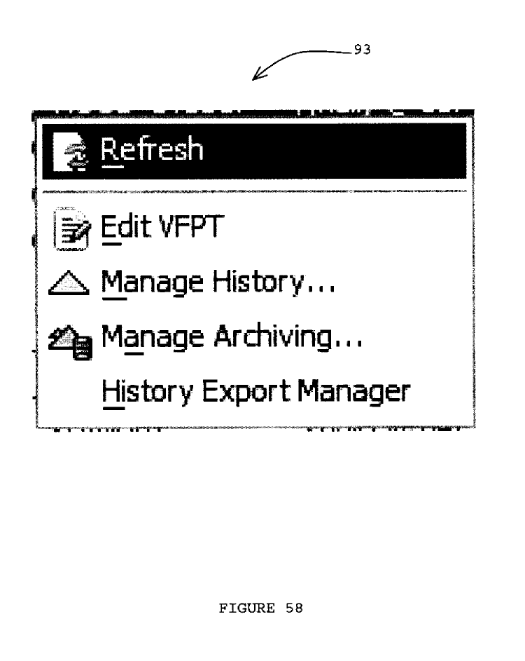

One may edit VFPT, manage history, manage archiving, and be a history export manager, as indicated by a screen 93 of a diagram in FIG. 58. One may right-click multiple Vantage points and edit and customize the control points. “Manage History” may be for either a single row or a group of rows.

If a single point is selected, that point's history screen may be displayed, depending on the point data type (AI, BO, MSI, MSO, and so forth). The screen may vary. Virtually all of the screens may have un-editable status and fault cause fields, and settings for enabled, active period, and interval. Enabled should be true for the function to work.

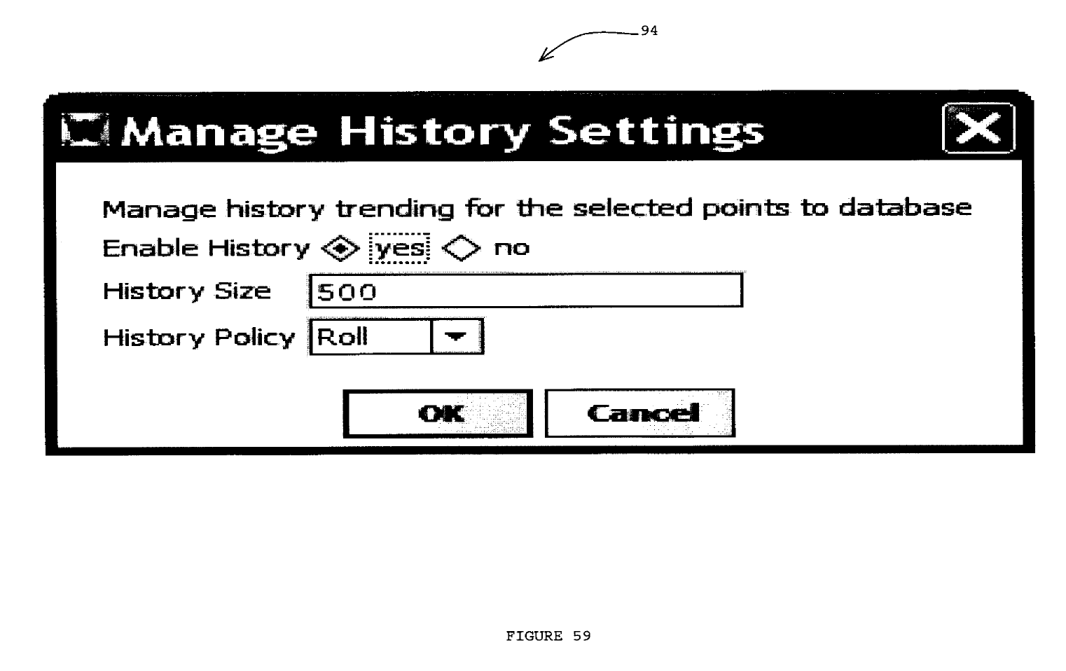

If multiple rows are selected, the Manage History Settings dialog screen 94 of the diagram in FIG. 59 may be launched. The yes option should be selected for enable history for the history trending function to work. The dialog box may be shown that allows user to adjust key properties (i.e., enable, history size, and rollover policy) of virtually all selected points.

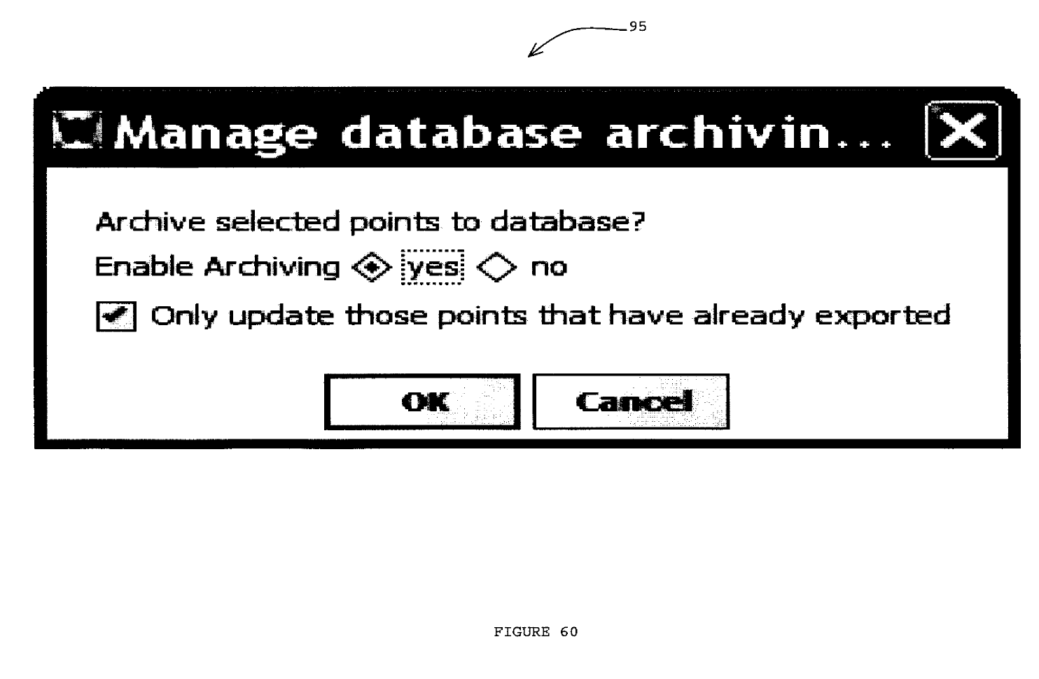

A manage database archiving screen 95 is shown in a diagram of FIG. 60. Manage archiving may be for single or multiple rows. Either choice may launch the same manage settings screen where one can enable/disable archiving. One should enable archiving for the setting to work. A check box may allow a user to update only those points that have already been exported.

Column of screen 92 of FIG. 57 may be described. Point Name may be a name of the source control point. Entity may be a name of the parent entity of this point. VFPT may be the point's functional type. Status may be a Niagara status flag for the source control point. Value may be a Niagara value (out slot) of the control point. Unit may indicate the data units for the numeric control point. Source may be a source device for the control point. History may be a text summation of history information for the point including enabled status, interval or COV point extension, record size, and time stamp for the last history record. Archive may be a text summation of archive activity/history information for the point. Dashboard may indicate that the point is either mapped or unmapped to one of the dashboards. Object type may be the BACnet object type. Object Instance # may be a BACnet object instance number. Out of Service may indicate whether the point is operative or inoperative.

To recap, a point configurator for a dashboard of a building system may incorporate a processor having a memory and a user interface connected to the processor. The user interface may incorporate a display, and a selection and information entry mechanism. The display may present control points and identify to which entity a control point has been mapped. An entity may be a physical component of a building system. The display may present a view that is customized for identification of points associated with a specific dashboard.

A history trend for multiple points may be managed. The history size and the roll-out policy may be specified. The multiple points of history may be to a database from a unified view. A user may have an ability to create a logical, hierarchal structure that represents a business and entity structure.

The entity may be selected from a group consisting of a building, floor, room and device of a building system. The group may consist of other components in the building system. A control point may need to be mapped to an entity, in order to be shown.

From a unified entity point of view, the user may reorganize control in a building system by a logical approach rather than physical components of the building system. Points, regardless of having a physical presence in the building system, may be viewed, monitored and managed using logical entities in a building.

A single view may be used to manage multiple entity points and trending. A unified view may be used to archive multiple entity points. Just entity points might be managed. A management view of entity points may support mapping entity points to corresponding entities and dashboards that are mapped.

An application may incorporate creating a hierarchy of entities selected from a group consisting of buildings, floors, rooms and devices of a building system, mapping entity points to entities, and selecting an entity from a group consisting of the buildings, floors, rooms and devices, from where the entity points are managed.

At a view from a descendant level, just the entity points of that level might be displayed. A descendant level may be a part of a hierarchy of levels, in that where a hierarchy may incorporate a building at a first level, a floor at a second level, a room at a third level, and a device at a fourth level. The fourth level may be a descendant level relative to the third, second and first levels, the third level may be a descendant level relative to the second and first levels, and the second level may be a descendant relative to the first level. There may be more or less levels in the hierarchy.

A menu may be available to obtain a point that is used to access a screen to manage history, archiving, and export history.

A query dashboard button on a screen in the display may be used to see a mapping of entity points relative to dashboards.

A clicking on multiple entity points on a screen in the display may enable one to see, edit and customize control points.

The screen to manage history may be accessed. To manage history may be for a single row or multiple rows. If a single row is selected, a history of a single point may be displayed on a screen. If multiple rows are selected, a manage history dialogue may be launched. The manage history dialogue may make available a history trending function.

Properties of selected points may be adjusted. The properties may incorporate enablement, history size and rollover policy.

The screen to manage archiving may be accessed. The manage archive may be for a single row or multiple rows. Selecting to manage archive for a single row or multiple rows may launch a configurator settings screen where archiving can be enabled or disabled.

The archiving may need to be enabled for a setting of the manage settings to operate. A check box may allow only points that have been exported to be updated.

An approach for dashboard configuration, may incorporate providing a computer, logging into a workbench via the computer, obtaining an entity, obtaining a dashboard pertinent to the entity, specifying one or more properties for a layout of the dashboard, dragging and dropping one or more gadgets from a file onto the dashboard, formatting the one or more gadgets, configuring the one or more gadgets, and saving the dashboard.

An entity may obtained by navigating to an entity or creating an entity. If the entity is obtained by creating, then the entity may be selected from a group consisting of physical components of a building system such as buildings, floors, rooms and devices. There may be other physical components in the group.

The gadgets may be dragged from a library or storage file and dropped onto the dashboard.

The gadgets may be formatted by resizing, moving left, moving right, moving up and moving down, marking, and swapping, as needed on the dashboard.

Configuring the gadgets may incorporate one or more items selected from a group consisting of point selection, property selection, time configuration, range selection for gauge gadgets, offset value determination, launch type selection, and chart type selection. There may be other items in the group.

The approach may further incorporate adding one or more algorithms to the entity. The one or more algorithms may be selected from a group consisting of zone air changes per hour (ACH), control status, flow cost, total flow offset, hood flow usage status, numeric aggregation, Boolean aggregation, and zone ACH status. There may be other algorithms in the group.

The gadgets dragged from the library may be gadgets selected from a group consisting of trend gadgets, point viewer gadgets, generic gauge gadgets, entity information gadgets, notes gadgets, point value gadgets, web connect gadgets, control loop gadgets, entity point table gadgets, alarm gadgets, ranking gadgets, point chart gadgets, and entity status gadgets. There may be other gadgets in the group.

Obtaining a dashboard may incorporate creating a new dashboard, or obtaining a dashboard may incorporate selecting a dashboard from a group consisting of customized dashboards. The customized dashboards may incorporate dashboards predefined for a building, floor, room, or device. There may be other kinds of dashboards.

A user may drag and drop predefined entities to a hierarchy. If the entity is obtained by creating, then the entity may be a predefined entity selected from a library.

The predefined entity may be a customized device. The customized device may be, for example, a ventilation hood. The ventilation hood may be a device to a room.

A dashboard configurator may incorporate a computer, a workbench logged in on the computer, an entity obtained on the workbench, a dashboard for the entity obtained, and one or more gadgets obtained. The one or more gadgets may be placed on the dashboard. The entity may be a physical component of a building system. The entity may be selected from a group consisting of a building, floor, room or device.

The one or more gadgets may have a format. The format of a gadget on a dashboard may incorporate being resized, moved in virtually any direction, marked, and swapped for placement of a gadget on the dashboard.

The one or more gadgets may be configured. A gadget may be configured according to one or more properties. The one or more properties may be selected from a group consisting of types, purposes, parameters, values, names, point lists, refresh intervals, ranges, status, descriptions, models, schemes, icons, point entity selectors, entity lists, VFPT's, alarm lists, chart types, ords, axes, offsets, notes, label links, images, data, control loops, algorithms, units, histories, sources, and launch types. There may be other properties.

One or more algorithms may be added to the entity. The one or more algorithms may be selected from a group consisting of zone ACH, control status, flow cost, total flow cost, flow usage status, numeric aggregator, Boolean aggregator, and zone ACH status.

The one or more gadgets may be selected from a group consisting of a trend gadget, point viewer gadget, generic gauge gadget, entity information gadget, notes gadget, point value gadget, canvas point gadget, web connect gadget, control loop gadget, entity point table gadget, alarm gadget, ranking gadget, point chart gadget, and entity status gadget.

The one or more gadgets may be auto populated with a user-defined configuration.

An entity may be a predefined entity. The predefined entity may be selected from a group consisting of buildings, floors, rooms, and devices. The predefined entity may be a customized entity dragged from a library or storage file to a hierarchy. A hierarchy may incorporate a device, a room, a floor and a building, in that order. There may be other kinds of hierarchies.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A point configurator for a dashboard of a building system, comprising:
a processor having a memory; and
a user interface connected to the processor; and
wherein:
the user interface comprises a display, and a selection and information entry mechanism;
the display can present control points and identify to which entity a control point has been mapped;
an entity is a physical component of a building system; and
the display presents a view that is customized for identification of points associated with a specific dashboard.

2. The configurator of claim 1, wherein:
a history trend for multiple points is managed;
the history size and the roll-out policy are specified; and
the multiple points of history are to a database from a unified view.

3. The configurator of claim 1, wherein the entity is selected from a group consisting of a building, floor, room and device of a building system.

4. The configurator of claim 2, wherein:
from a unified entity point of view, the user reorganizes control in a building system by a logical approach rather than physical components of the building system;
points, regardless of having a physical presence in the building system, are viewed, monitored and managed using logical entities in a building;
a single view is used to manage multiple entity points and trending;
a unified view is used to archive multiple entity points;
just entity points are managed; or
management view an entity points supports mapping entity points to corresponding entities and dashboards that are mapped.

5. The configurator of claim 1, wherein an application comprises:
creating a hierarchy of entities selected from a group consisting of buildings, floors, rooms and devices of a building system;
mapping entity points to entities; and
selecting an entity from a group consisting of the buildings, floors, rooms and devices, from where the entity points are managed; and
wherein:
at a view from a descendant level, just the entity points of that level are displayed;
a descendant level is a part of a hierarchy of levels, in that where a hierarchy comprises a building at a first level, a floor at a second level, a room at a third level, and a device at a fourth level; or
the fourth level is a descendant level relative to the third, second and first levels, the third level is a descendant level relative to the second and first levels, and the second level is a descendant relative to the first level.

6. The configurator of claim 1, wherein:
a menu is available to obtain a point that is used to access a screen to manage history, archiving, and export history;
the screen to manage history is accessed;
to manage history is for a single row or multiple rows;
if a single row is selected, a history of the single point is displayed on a screen;
if multiple rows are selected, a manage history dialogue is launched;
the manage history dialogue makes available a history trending function;
properties of selected points can be adjusted; or
the properties comprise enablement, history size and rollover policy.

7. The configurator claim 1, wherein:
the screen to manage archiving is accessed;
the manage archive is for a single row or multiple rows;
selecting to manage archive for a single row or multiple rows launches a configurator settings screen where archiving can be enabled or disabled;
the archiving needs to be enabled for a setting of the manage settings to operate; or
a check box allows only points that have been exported to be updated.

8. A method for dashboard configuration, comprising:
providing a computer;
logging into a workbench via the computer;
obtaining an entity;
obtaining a dashboard pertinent to the entity;
specifying one or more properties for a layout of the dashboard;
dragging and dropping one or more gadgets from a file onto the dashboard;
formatting the one or more gadgets;
configuring the one or more gadgets; and
saving the dashboard.

9. The method of claim 8, wherein
an entity is obtained by navigating to an entity or creating an entity; and
if the entity is obtained by creating, then the entity is selected from a group consisting of various physical components of a building system.

10. The method of claim 8, wherein the gadgets are formatted by resizing, moving in virtually any direction, marking, or swapping, as needed on the dashboard.

11. The method of claim 8, wherein configuring the gadgets according to one or more properties selected from a group consisting of point selection, property selection, time configuration, range selection for gauge gadgets, offset value determination, launch type selection, and chart type selection.

12. The method of claim 8, wherein:
obtaining a dashboard comprises creating a new dashboard; or
obtaining a dashboard comprises selecting a dashboard from a group consisting of customized dashboards.

13. The method of claim 12, wherein:
the customized dashboards comprise dashboards predefined for a building, floor, room, or device;
a user can drag and drop predefined entities to a hierarchy;
one or more algorithms are added to an entity; and
if the entity is obtained by creating, then the entity can be a predefined entity selected from a library or storage file.

14. A dashboard configurator comprising:
a computer;
a workbench logged in on the computer;
an entity obtained on the workbench;
a dashboard for the entity is obtained; and
one or more gadgets are obtained; and
wherein:
the one or more gadgets are placed on the dashboard; and
the entity is a physical component of a building system.

15. The configurator of claim 14, wherein:
the one or more gadgets have a format; and
the format of a gadget on a dashboard comprises being resized, moved in virtually any direction, marked, and swapped for placement of a gadget on the dashboard.

16. The configurator of claim 14, wherein:
the one or more gadgets are configured;
a gadget is configured according to one or more properties; and
the one or more properties are selected from a group consisting of types, purposes, parameters, values, names, point lists, refresh intervals, ranges, status, descriptions, models, schemes, icons, point entity selectors, entity lists, VFPT's, alarm lists, chart types, ords, axes, offsets, notes, label links, images, data, control loops, algorithms, units, histories, sources, and launch types.

17. The configurator of claim 14, wherein:
one or more algorithms are added to the entity; and
the one or more algorithms are selected from a group consisting of zone ACH, control status, flow cost, total flow cost, flow usage status, numeric aggregator, Boolean aggregator, and zone ACH status.

18. The configurator of claim 14, wherein the one or more gadgets are selected from a group consisting of a trend gadget, point viewer gadget, generic gauge gadget, entity information gadget, notes gadget, point value gadget, canvas point gadget, web connect gadget, control loop gadget, entity point table gadget, alarm gadget, ranking gadget, point chart gadget, and entity status gadget.

19. The configurator of claim 14, wherein:
an entity is a predefined entity;
the predefined entity is selected from a group consisting of buildings, floors, rooms, and devices;
the predefined entity is a customized entity dragged from a library to a hierarchy; and
a hierarchy comprises a device, a room, a floor and a building, in that order.

20. The configurator of claim 14, wherein the one or more gadgets are auto populated with a user-defined configuration.
